(19) United States
(12) Patent Application Publication
(10) Pub. No.: US 2003/0145030 A1
(43) Pub. Date: Jul. 31, 2003

(54) Multiply-accumulate accelerator with data re-use

(76) Inventor: Gad S. Sheaffer, Haifa (IL)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/062,143

(22) Filed: Jan. 31, 2002

(51) Int. Cl. G06F 7/38

(52) U.S. Cl. 708/523; 708/603

(57) ABSTRACT

Input data is received by an execution unit. One or more current multiply-accumulate operations are performed by the execution unit on the received input data and on input data received by the execution unit for one or more prior multiply-accumulate operations and saved by the execution unit.

### BACKGROUND OF THE INVENTION

1. Field of the Invention

The present invention relates generally to the field of computer systems. More particularly, the present invention relates to the field of multiply-accumulate operations performed by computer systems.

2. Description of Related Art

To address the needs of multi-media, communications, and graphics applications, computer systems have been designed to support one or more digital signal processing techniques to process, for example, analog data, video data, and/or audio data. Typical digital signal processing techniques include image processing, video compression, video decompression, audio compression, audio decompression, and digital filtering. These techniques typically use sophisticated algorithms that perform the same operations, such as a multiply-accumulate operation for example, on a relatively large number of data in units of bytes, words, or doublewords, for example.

A typical computer system supports multiply-accumulate operations with one or more instructions and one or more execution units capable of performing multiplication and addition. As one example, the Intel® 32-bit Architecture as defined by Intel® Corporation of Santa Clara, Calif. supports multiply-accumulate operations with an instruction to multiply and add packed integers. The instruction is known as a PMADDWD instruction.

### BRIEF DESCRIPTION OF THE DRAWINGS

The present invention is illustrated by way of example and not limitation in the figures of the accompanying drawings, in which like references indicate similar elements and in which:

FIG. 1 illustrates an exemplary computer system comprising a processor having one or more multiplier-accumulator (MAC) execution units;

FIG. 2 illustrates, for one embodiment, a processor having one or more MAC execution units;

FIG. 3 illustrates, for one embodiment, a single multiplier-accumulator;

FIG. 4 illustrates, for one embodiment, a MAC execution unit;

FIG. 5 illustrates, for one embodiment, a flow diagram to perform one or more multiply-accumulate operations;

FIG. 6 illustrates, for one embodiment, a MAC execution unit building block;

FIG. 7 illustrates, for another embodiment, a MAC execution unit building block;

FIG. 8 illustrates, for another embodiment, a MAC execution unit;

FIG. 9 illustrates, for one embodiment, a table illustrating the operation of the MAC execution unit of FIG. 8;

FIG. 10 illustrates, for one embodiment, a dual multiplier-accumulator;

FIG. 11 illustrates, for another embodiment, a MAC execution unit building block;

FIG. 12 illustrates, for another embodiment, a MAC execution unit building block;

FIG. 13 illustrates, for another embodiment, a MAC execution unit;

FIG. 14 illustrates, for one embodiment, a table illustrating the operation of the MAC execution unit of FIG. 13;

FIG. 15 illustrates, for another embodiment, a MAC execution unit;

FIG. 16 illustrates, for one embodiment, a table illustrating the operation of the MAC execution unit of FIG. 15;

FIG. 17 illustrates, for another embodiment, a MAC execution unit;

FIG. 18 illustrates, for one embodiment, a table illustrating the operation of the MAC execution unit of FIG. 17;

FIG. 19 illustrates, for another embodiment, a MAC execution unit;

FIG. 20 illustrates, for one embodiment, a table illustrating the operation of the MAC execution unit of FIG. 19;

FIG. 21 illustrates, for another embodiment, a MAC execution unit;

FIG. 22 illustrates, for one embodiment, a table illustrating the operation of the MAC execution unit of FIG. 21;

FIG. 23 illustrates, for another embodiment, a MAC execution unit;

FIG. 24 illustrates, for one embodiment, a table illustrating the operation of the MAC execution unit of FIG. 23;

FIG. 25 illustrates, for another embodiment, a MAC execution unit;

FIG. 26 illustrates, for one embodiment, a table illustrating the operation of the MAC execution unit of FIG. 25;

FIG. 27 illustrates, for another embodiment, a MAC execution unit; and

FIG. 28 illustrates, for one embodiment, a table illustrating the operation of the MAC execution unit of FIG. 27.

### DETAILED DESCRIPTION

The following detailed description sets forth an embodiment or embodiments in accordance with the present invention for multiply-accumulate accelerator with data re-use. In the following description, details are set forth such as specific filters, filter applications, algorithms, etc., in order to provide a thorough understanding of the present invention. It will be evident, however, that the present invention may be practiced without these details. In other instances, well-known computer components, etc., have not been described in particular detail so as not to obscure the present invention.

### Exemplary Computer System

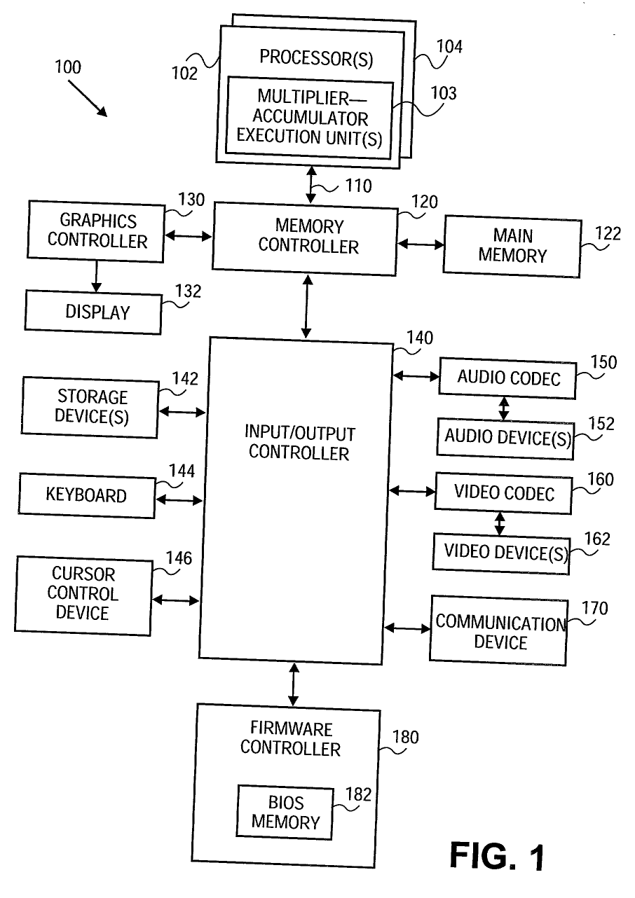

FIG. 1 illustrates an exemplary computer system 100 comprising a processor 102 having one or more multiplier-accumulator (MAC) execution units 103. Although described in the context of computer system 100, the present invention may be used with any suitable computer system comprising any suitable one or more devices. Suitable computer systems include, without limitation, personal desktop and notebook computer systems, tablet computer systems, digital cellular telephone systems, and personal digital assistants (PDAs), for example.

As illustrated in FIG. 1, computer system 100 comprises another processor 104 that may also have one or more multiplier-accumulator execution units. Processors 102 and 104 may each comprise any suitable processor architecture such as, for example, the Intel® 32-bit Architecture or the Intel® 64-bit Architecture as defined by Intel® Corporation of Santa Clara, Calif. Although described in the context of two processors 102 and 104, computer system 100 for other embodiments may comprise one, three, or more processors any of which may comprise one or more multiplier-accumulator execution units.

Computer system 100 also comprises a memory controller 120. Processors 102 and 104 and memory controller 120 for one embodiment are each coupled to one another by a processor bus 110. Memory controller 120 may comprise any suitable circuitry formed on any suitable one or more integrated circuit chips.

Memory controller 120 may comprise any suitable interface controllers to provide for any suitable communication link to processor bus 110 and/or to any suitable device in communication with memory controller 120. Memory controller 120 for one embodiment may provide suitable arbitration, buffering, and coherency management for each interface.

Memory controller 120 provides an interface to processor 102 and/or processor 104 over processor bus 110. For one embodiment, processor 102 or 104 may alternatively be combined with memory controller 120 to form a single integrated circuit chip. Memory controller 120 for one embodiment also provides an interface to a main memory 122, a graphics controller 130, and an input/output (I/O) controller 140.

Main memory 122 is coupled to memory controller 120 to load and store data and/or instructions, for example, for computer system 100. Main memory 122 may comprise any suitable memory, such as suitable dynamic random access memory (DRAM) for example.

Graphics controller 130 is coupled to memory controller 120 to control the display of information on a suitable display 132, such as a cathode ray tube (CRT) or liquid crystal display (LCD) for example, coupled to graphics controller 130. Memory controller 120 for one embodiment interfaces with graphics controller 130 through an accelerated graphics port (AGP). Graphics controller 130 for one embodiment may alternatively be combined with memory controller 120 to form a single integrated circuit chip.

I/O controller 140 is coupled to memory controller 120 to provide an interface to one or more I/O devices coupled to I/O controller 140. I/O controller 140 may comprise any suitable interface controllers to provide for any suitable communication link to memory controller 120 and/or to any suitable device in communication with I/O controller 140. I/O controller 140 for one embodiment may provide suitable arbitration and buffering for each interface.

For one embodiment, I/O controller 140 may provide an interface to one or more storage devices 142, such as a hard disk drive (HDD), a floppy disk drive, a compact disc (CD) drive, and/or a digital versatile disc (DVD) drive, for example, to store data and/or instructions, for example. I/O controller 140 for one embodiment may also provide an interface to a keyboard 144 and a cursor control device 146, such as a mouse, joystick, or touch tablet for example.

I/O controller 140 for one embodiment may provide an interface to an audio coder/decoder (codec) 150 to convert analog audio signals output from one or more suitable audio devices 152 into corresponding digital audio signals and/or to convert digital audio signals into corresponding analog audio signals for output to audio device(s) 152. Audio device(s) 152 may include, for example, one or more microphones and/or speakers for example. I/O controller 140 for one embodiment may provide an interface to a video codec 160 to convert analog video signals output from one or more suitable video devices 162 into corresponding digital video signals and/or to convert digital video signals into corresponding analog video signals for output to video device(s) 162. Video device(s) 162 may include, for example, a video camcorder or video cassette recorder (VCR) for example.

I/O controller 140 for one embodiment may provide an interface to a communication device 170 to convert digital signals into analog signals for transmission to one or more other computer systems over one or more networks, including the Internet for example. Communication device 170 for one embodiment may comprise, for example, a modem codec or a radio frequency interface.

I/O controller 140 is also coupled to a firmware controller 180 to provide an interface to firmware controller 180. Firmware controller 180 comprises a basic input/output system (BIOS) memory 182 to store suitable system and/or video BIOS software. BIOS memory 182 may comprise any suitable non-volatile memory, such as a flash memory for example.

### Processor Comprising MAC Execution Unit(s)

Processor 102 comprises one or more multiplier-accumulator (MAC) execution units 103 to help accelerate the performance of multiply-accumulate operations. Processor 102 for one embodiment may use one or more MAC execution units 103 in performing digital signal processing, for example, on signals received through audio codec 150, video codec 160, and/or communication device 170 for example.

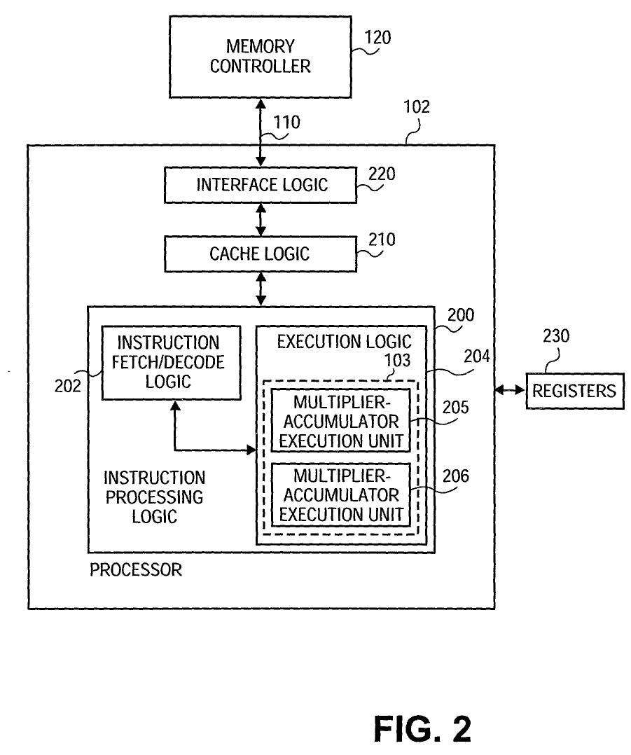

As illustrated in FIG. 2, processor 102 for one embodiment comprises instruction processing logic 200, cache logic 210, interface logic 220, and registers 230. Interface logic 220 couples cache logic 210 to processor bus 110 and may comprise any suitable circuitry. Cache logic 210 and registers 230 are coupled to instruction processing logic 200.

Cache logic 210 helps supply instructions and/or data to instruction processing logic 200. Cache logic 210 may store instructions and/or data accessed from main memory 122 through interface logic 210 and memory controller 120 for processing by instruction processing logic 200. Cache logic 210 may also store recently and/or frequently used instructions and/or data to help minimize accesses to main memory 122.

Cache logic 210 may comprise any suitable circuitry. Cache logic 210 for one embodiment may implement a two cache level memory subsystem in which cache memory at a primary cache level is relatively small in size and closely coupled to instruction processing logic 200 to facilitate relatively quicker access of instructions and/or data stored at the primary cache level while cache memory at a secondary cache level stores relatively more instructions and/or data yet has a relatively slower access time. Cache logic 210 for one embodiment may implement a dedicated instruction cache memory portion and a separate dedicated data cache memory portion at the primary cache level. Cache logic 210 for other embodiments may implement one, three, or more cache levels. Cache logic 210 may store instructions and/or data for instruction processing logic 200 in accordance with any suitable caching scheme.

Instruction processing logic 200 may comprise any suitable circuitry to fetch and process instructions and/or data. Instruction processing logic 200 for one embodiment, as illustrated in FIG. 2, comprises an instruction pipeline comprising instruction fetch/decode logic 202 and execution logic 204 coupled to instruction fetch/decode logic 202.

Instruction fetch/decode logic 202 fetches instructions from cache logic 210. Instruction fetch/decode logic 202 may comprise any suitable circuitry to fetch instructions in any suitable manner. Instruction fetch/decode logic 202 for one embodiment may identify a next instruction to be fetched by instruction processing logic 200 in accordance with an instruction pointer maintained by instruction fetch/decode logic 202 and may request the instruction from cache logic 210. Cache logic 210 may identify whether the requested instruction is stored in cache memory and, if not, may request the instruction from main memory 122 through interface logic 220 and memory controller 120. Instruction fetch/decode logic 202 may identify the next instruction, for example, as the next sequential instruction in a program, as a predicted or actual destination of a branch instruction, or as the start of a new routine, such as an exception handling routine for example.

Instruction fetch/decode logic 202 for one embodiment may decode each instruction into one or more micro-operations. Instruction fetch/decode logic 202 for one embodiment may decode each instruction into one or more triadic micro-operations. A triadic micro-operation comprises an operation code or opcode and may comprise up to two logical source operands and one logical destination operand.

Execution logic 204 executes the micro-operations generated by instruction fetch/decode logic 202. Execution logic 204 may comprise any suitable circuitry and for one embodiment comprises a plurality of execution units including one or more multiplier-accumulator (MAC) execution units 103. As illustrated in FIG. 2, execution logic 204 for one embodiment may comprise two MAC execution units 205 and 206. For other embodiments, execution logic 204 may comprise one, three, or more MAC execution units. Execution logic 204 for one embodiment may also comprise one or more integer execution units, one or more floating point execution units, and/or a memory interface execution unit for example. Execution logic 204 may dispatch each micro-operation to an appropriate execution unit available to execute the micro-operation.

Execution logic 204 for one embodiment executes one or more memory load micro-operations by dispatching the memory load micro-operation to a memory interface execution unit coupled to cache logic 210 to request data from cache memory or main memory 122. Execution logic 204 may then store the requested data in one or more registers of registers 230 or may allow access to the requested data through one or more memory ports for use by any execution unit in executing a micro-operation.

Execution logic 204 for one embodiment may execute micro-operations in the order they are generated by instruction fetch/decode logic 202. Execution logic 204 for another embodiment may comprise suitable circuitry to execute micro-operations out-of-order to help increase instruction throughput.

Although described in the context of instruction processing logic 200 as illustrated in FIG. 2, one or more MAC execution units 103 may be implemented using any suitable processor architecture. As one example, instruction fetch/decode logic 202 for another embodiment may not decode one or more fetched instructions into micro-operations but rather may process each instruction for execution directly. As another example, one or more MAC execution units 103 may be implemented with any suitable digital signal processor (DSP) architecture.

### Multiplier-Accumulator Execution Unit

Multiplier-accumulator (MAC) execution unit 205 for one embodiment may be implemented in a modular manner using a multiplier-accumulator (MAC) as a basic building block. Although described in the context of being used to implement MAC execution unit 205, MAC basic building blocks may be used to implement any one or more other MAC execution units, such as MAC execution unit 206 for example, of MAC execution unit(s) 103. One or more MAC execution units of MAC execution unit(s) 103 may or may not be implemented similarly.

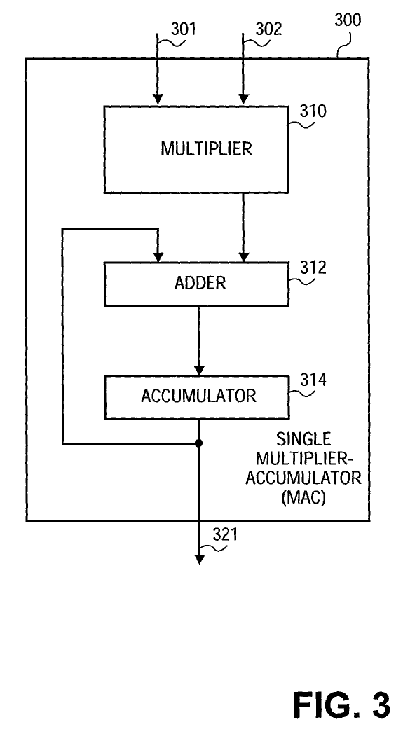

MAC execution unit 205 for one embodiment may be implemented using a single MAC 300, as illustrated in FIG. 3, as a basic building block. Single MAC 300 has a first input 301 to receive first input data and a second input 302 to receive second input data. Single MAC 300 comprises a multiplier 310, an adder 312, and an accumulator 314. Multiplier 310 is coupled to receive as inputs the first input data and the second input data and may multiply the first and second input data to produce and output a product. Adder 312 is coupled to receive as inputs the product output from multiplier 310 and an accumulated sum stored in accumulator 314. Adder 312 may add the output product and the accumulated sum, if any, to produce and output a sum. Accumulator 314 is coupled to receive and store the sum output from adder 312. Accumulator 314 is also coupled to output the accumulated sum stored in accumulator 314 at an output 321 of single MAC 300.

Multiplier 310 and adder 312 may operate on data of any suitable size, and accumulator 314 may store data of any suitable size. Multiplier 310, adder 312, and accumulator 314 for one embodiment are designed such that single MAC 300 may operate on 16-bit input data, for example. Adder 312 and/or accumulator 314 for one embodiment may support larger precision data, such as 32-bit data for example.

Single MAC 300 for one embodiment may comprise suitable circuitry to convert the value of the first input data, the value of the second input data, or the product produced by multiplier 310 to its additive inverse. In this manner, adder 312 may effectively subtract the product of the first input data and the second input data from the value of the data stored in accumulator 314. Single MAC 300 for one embodiment may comprise suitable circuitry to allow single MAC 300 to be selectively controlled either to add the product of the first input data and the second input data to the value of the data stored in accumulator 314 or to subtract the product of the first input data and the second input data from the value of the data stored in accumulator 314.

Single MAC 300 for another embodiment may comprise a subtractor in addition to adder 312 to subtract the product output from multiplier 310 from the value of the data stored in accumulator 314 and to output the result to accumulator 314. Single MAC 300 for one embodiment may comprise suitable circuitry to allow single MAC 300 to be selectively controlled to add the product of the first input data and the second input data to the value of the data stored in accumulator 314 and/or to subtract the product of the first input data and the second input data from the value of the data stored in accumulator 314.

Single MAC 300 for another embodiment may comprise a subtractor instead of adder 312 to subtract the product output from multiplier 310 from the value of the data stored in accumulator 314 and output the result to accumulator 314.

MAC execution unit 205 may comprise any suitable number of one or more MACs to help accelerate any suitable computation involving multiplication and/or addition/subtraction operations. MAC execution unit 205 for one embodiment may comprise a plurality of MACs to perform multiple multiply-accumulate operations during a single computation cycle to help accelerate computations involving the summation of products. MAC execution unit 205 for one embodiment at least partially overlaps the performance of multiple multiply-accumulate operations in time during a single computation cycle.

For one embodiment, MAC execution unit 205 may comprise a plurality of MACs to help accelerate multiply-accumulate operations to implement a finite impulse response (FIR) digital filter for one or more digital signal processing applications, such as a modem data pump for example. A FIR digital filter is used to help recover information from analog signals converted into digital signals. Although described in the context of performing multiply-accumulate operations to implement a FIR digital filter, MAC execution unit 205 may comprise a plurality of MACs for any suitable one or more applications.

MAC execution unit 205 for one embodiment helps compute one or more FIR digital filter output data samples by multiplying input data samples from filter delay line taps by corresponding filter tap coefficients and accumulating the resulting products in accordance with the following Equation 1:

$$y ( k ) = {\sum }_{n = 0}^{L - 1} c ( n ) * x ( k - n ) \qquad \text{Equation 1}$$

where:

L=length or number of tap coefficients of the filter;

c(n)=the nth tap coefficient of the filter;

x(k−n)=the nth past input data sample relative to the kth input data sample; and

y(k)=kth output data sample of the filter.

For the computation of the kth output data sample y(k), the first filter coefficient c(0) is multiplied by the kth input data sample, the second filter coefficient c(1) is multiplied by the (k−1)th input data sample, etc., and the resulting products are summed to produce the output data sample y(k).

With complex input data samples, MAC execution unit 205 may help compute the real and imaginary components for the FIR digital filter output data samples in accordance with the following Equations 2 and 3, respectively.

$$\begin{matrix}y ( k ) \cdot real = {\sum }_{n = 0}^{L - 1} ( c ( n ) \cdot real * x ( k - n ) \cdot real - c ( n ) \cdot imag * x ( k - n ) \cdot imag ) & \text{Equation 2} \\ y ( k ) \cdot imag = {\sum }_{n = 0}^{L - 1} ( c ( n ) \cdot real * x ( k - n ) \cdot imag + c ( n ) \cdot imag * x ( k - n ) \cdot real ) & \text{Equation 3}\end{matrix}$$

MAC execution unit 205 for one embodiment may comprise one or more buffers coupled to one or more MACs to store and therefore save one or more input data that may be re-used in performing multiply-accumulate operations. Each buffer may be implemented using any suitable circuitry to store data of any suitable size. For one embodiment, one or more buffers may each be implemented using D-type flip-flops, for example, to store 16-bit data, for example.

Using the above FIR digital filter Equation 1 as an example, MAC execution unit 205 may save input data sample x(−1), for example, for re-use because input data sample x(−1) is to be multiplied, for example, by tap coefficient c(1) when k=0 and n=1 and by tap coefficient c(2) when k=1 and n=2.

Re-using one or more input data for one or more additional multiply-accumulate operations helps increase the ratio of-computation to data input bandwidth as MAC execution unit 205 for one embodiment may perform relatively more multiply-accumulate operations during a computation cycle relative to any increase in the number of input data to perform those multiply-accumulate operations during that computation cycle. For a given data input bandwidth per computation cycle for MAC execution unit 205, MAC execution unit 205 for one embodiment may therefore perform relatively more multiply-accumulate operations for a computation cycle by re-using one or more input data across computation cycles. For a given number of multiply-accumulate operations per computation cycle, MAC execution unit 205 for one embodiment may therefore use less data input bandwidth by re-using one or more input data across computation cycles. For one embodiment, more memory bandwidth may then be made available for use for other instructions.

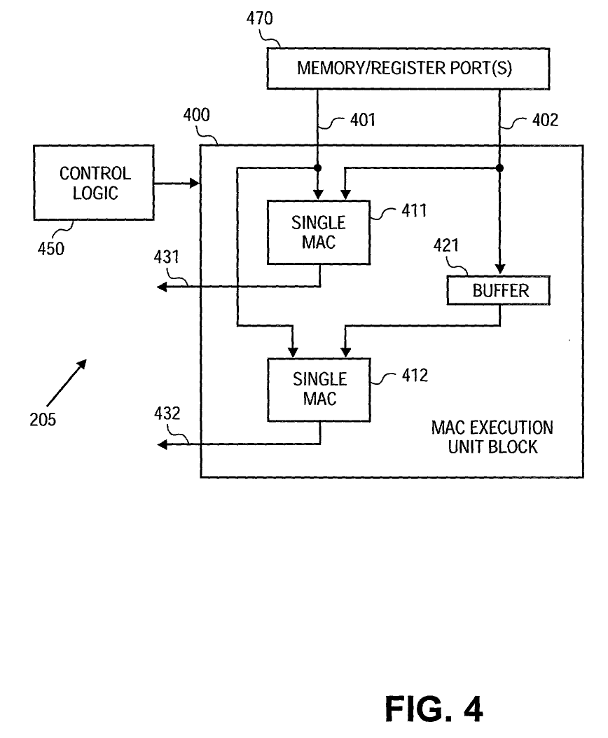

As illustrated in FIG. 4, MAC execution unit 205 for one embodiment may comprise a MAC execution unit block 400 and control logic 450 coupled to MAC execution unit block 400. MAC execution unit block 400 has inputs 401 and 402 and outputs 431 and 432 and comprises two single MACs 411 and 412 and a buffer 421. Single MACs 411 and 412 for one embodiment may each be similar to single MAC 300 as illustrated in FIG. 3. Single MAC 411 is coupled to receive input data at inputs 401 and 402 and to output data at output 431. Single MAC 412 is coupled to receive input data at input 401 and input data output from buffer 421 and to output data at output 432. Buffer 421 is coupled to receive and store input data at input 402 and to output the stored input data to single MAC 412.

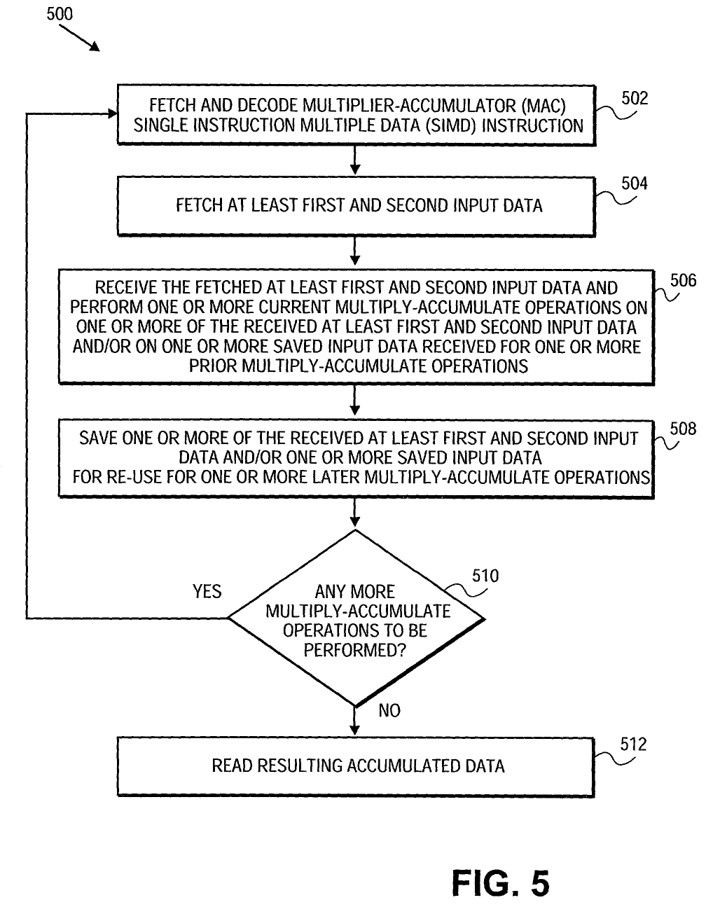

Instruction processing logic 200 may perform one or more multiply-accumulate operations using MAC execution unit 205 in any suitable manner. Instruction processing logic 200 for one embodiment may perform one or more multiply-accumulate operations using MAC execution unit 205 in accordance with a flow diagram 500 as illustrated in FIG. 5.

For block 502 of FIG. 5, instruction fetch/decode logic 202 fetches and decodes a multiplier-accumulator (MAC) single instruction multiple data (SIMD) instruction to perform one or more multiply-accumulate operations. The MAC SIMD instruction may have any suitable format.

For block 504, execution logic 204 fetches at least first and second input data in response to the MAC SIMD instruction. Execution logic 204 for one embodiment may request any of the at least first and second input data from cache logic 210. Execution logic 204 may then allow access to the requested input data from MAC execution unit 205 through one or more memory ports or may store the requested data in one or more registers of registers 230 and allow access to the requested data from MAC execution unit 205 through one or more register ports. Execution logic 204 for one embodiment may read any of the at least first and second input data already loaded in registers 230 from registers 230. The fetched input data may have any suitable size and may be stored in any suitable format. For one embodiment, the fetched input data may each be 16 bits in size. The fetched first and second input data for one embodiment may be in a packed format and made available for access for MAC execution unit 205 through one memory or register port.

Referring to the embodiment illustrated in FIG. 4, inputs 401 and 402 are coupled to receive fetched first and second input data, respectively, through one or more memory or register ports 470.

For block 506, MAC execution unit 205, in response to the MAC SIMD instruction, receives the fetched at least first and second input data and performs one or more current multiply-accumulate operations on one or more of the received at least first and second input data and/or on one or more saved input data received by MAC execution unit 205 for one or more prior multiply-accumulate operations. A multiply-accumulate operation comprises multiplying at least two input data and adding the resulting product to, or subtracting the resulting product from, at least data stored in an accumulator to update data in the accumulator. MAC execution unit 205 for one embodiment may perform the one or more current multiply-accumulate operations during one computation cycle.

Referring to the embodiment illustrated in FIG. 4, control logic 450 may control single MAC 411 to receive the first and second input data at inputs 401 and 402, respectively, and to perform a multiply-accumulate operation on the first and second input data during a current computation cycle. Control logic 450 may also control single MAC 412 to receive the first input data at input 401 and any saved input data stored in buffer 421 and to perform a multiply-accumulate operation on the first input data and any saved input data stored in buffer 421 during the current computation cycle.

For block 508, MAC execution unit 205 saves for re-use for one or more later multiply-accumulate operations one or more of the received at least first and second input data and/or one or more saved input data received by MAC execution unit 205 for one or more prior multiply-accumulate operations. MAC execution unit 205 for one embodiment may store any of the received input data and/or any saved input data in one or more buffers for re-use for one or more multiply-accumulate operations during one or more later computation cycles. MAC execution unit 205 for one embodiment may save any received input data in any one or more buffers for any suitable number of computation cycles.

Referring to the embodiment illustrated in FIG. 4, control logic 450 may control buffer 421 to save or store the second input data at input 402 for re-use for a multiply-accumulate operation to be performed by single MAC 412 during another computation cycle.

If any more multiply-accumulate operations are to be performed for block 510, instruction processing logic 200 may then repeat the operations for blocks 502-508. Otherwise, instruction processing logic 200 for block 512 may read one or more accumulated data. For one embodiment, instruction fetch/decode logic 202 may fetch and decode a MAC read instruction to output one or more accumulated data from MAC execution unit 205 and to store the output accumulated data to registers 230 and/or to memory. The MAC read instruction may have any suitable format. Instruction processing logic 200 for one embodiment supports saturation, down shifting for precision adjustment, and/or packing for the accumulated data.

Referring to the embodiment illustrated in FIG. 4, control logic 450 may control single MAC 411 to output at output 431 accumulated data resulting from one or more multiply-accumulate operations performed by single MAC 411. Control logic 450 may also control single MAC 412 to output at output 432 accumulated data resulting from one or more multiply-accumulate operations performed by single MAC 412. Control logic 450 for one embodiment may control both single MAC 411 and single MAC 412 to output accumulated data substantially simultaneously. For another embodiment, MAC execution unit block 400 may have an output common to both single MAC 411 and 412. Control logic 450 may then control single MAC 411 and single MAC 412 to output accumulated data at the common output at different times.

Instruction processing logic 200 for one embodiment may perform the above FIR digital filter Equation 1, for example, by repeating blocks 502-508 to perform multiply-accumulate operations until one or more output data samples y(k) have been computed. For one embodiment, the tap coefficients for the filter may be stored in one memory bank while the input data samples may be stored in a different memory bank. For one embodiment, instruction processing logic 200 may initially store the tap coefficients for the filter in registers 230 to help reduce memory bandwidth in fetching input data for MAC execution unit 205.

Referring to the embodiment illustrated in FIG. 4, control logic 450 may control single MAC 411 to compute y(1) and single MAC 412 to compute y(0) for this example.

Given a filter length of L=32, for example, instruction fetch/decode logic 202 for block 502 fetches and decodes an initial MAC SIMD instruction identifying a tap coefficient of zero and input data sample x(−31) as inputs to perform the initial MAC SIMD instruction. The tap coefficient for the initial MAC SIMD instruction is zero because this MAC SIMD instruction is performed only to store input data sample x(−31) in buffer 421.

For block 504, execution logic 204 fetches, if necessary, the zero tap coefficient and input data sample x(−31).

For block 506, control logic 450 controls single MAC 411 to multiply the zero tap coefficient by input data sample x(−31) and add the resulting product, that is zero, to the accumulated data maintained by single MAC 411. As control logic 450 for one embodiment may have previously cleared the accumulator of single MAC 411, the accumulated data maintained by single MAC 411 to compute y(1) remains zero. Control logic 450 also controls single MAC 412 to multiply the zero tap coefficient by any data stored in buffer 421 and add the resulting product, that is zero, to the accumulated data maintained by single MAC 412. As control logic 450 for one embodiment may have previously cleared the accumulator of single MAC 412, the accumulated data maintained by single MAC 412 to compute y(0) remains zero.

For block 508, control logic 450 controls buffer 421 to store input data sample x(−31).

In repeating blocks 502-508, instruction fetch/decode logic 202 fetches and decodes another MAC SIMD instruction identifying tap coefficient c(31) and input data sample x(−30) as inputs to perform the MAC SIMD instruction.

For block 504, execution logic 204 fetches, if necessary, tap coefficient c(31) and input data sample x(−30).

For block 506, control logic 450 controls single MAC 411 to multiply tap coefficient c(31) by input data sample x(−30) and add the resulting product to the accumulated data, that is zero, maintained by single MAC 411. Control logic 450 also controls single MAC 412 to multiply tap coefficient c(31) by input data sample x(−31) stored in buffer 421 and add the resulting product to the accumulated data, that is zero, maintained by single MAC 412.

For block 508, control logic 450 controls buffer 421 to store input data sample x(−30).

In repeating blocks 502-508, instruction fetch/decode logic 202 fetches and decodes another MAC SIMD instruction identifying tap coefficient c(30) and input data sample x(−29) as inputs to perform the MAC SIMD instruction.

For block 504, execution logic 204 fetches, if necessary, tap coefficient c(30) and input data sample x(−29).

For block 506, control logic 450 controls single MAC 411 to multiply tap coefficient c(30) by input data sample x(−29) and add the resulting product to the accumulated data, that is the product of c(31)*x(−30), maintained by single MAC 411. Control logic 450 also controls single MAC 412 to multiply tap coefficient c(30) by input data sample x(−30) stored in buffer 421 and add the resulting product to the accumulated data, that is the product of c(31)*x(−31), maintained by single MAC 412.

For block 508, control logic 450 controls buffer 421 to store input data sample x(−29).

Instruction processing logic 200 may repeat blocks 502-508 in this manner until single MAC 411 performs a multiply-accumulate operation on tap coefficient c(0) and input data sample x(1) and single MAC 412 performs a multiply-accumulate operation on tap coefficient c(0) and input data sample x(0). As the accumulated data maintained by single MAC 411 is then the output data sample y(1) and the accumulated data maintained by single MAC 412 is then the output data sample y(0), instruction processing logic 200 for block 512 may read the accumulated data from single MAC 411 and single MAC 412.

Because MAC execution unit 205 saves and re-uses input data samples, MAC execution unit 205 for this example uses only two input data to perform two multiply-accumulate operations for each computation cycle after performing the initial MAC SIMD instruction to initially load buffer 421.

Although described in the context of performing multiply-accumulate operations using a SIMD technique, MAC execution unit 205 for another embodiment may be controlled to perform one or more multiply-accumulate operations using any other suitable technique.

Although described in connection with the embodiment of MAC execution unit 205 as illustrated in FIG. 4 as an example, instruction processing logic 200 may perform one or more multiply-accumulate operations using any other suitable embodiment of MAC execution unit 205 in accordance with flow diagram 500 of FIG. 5.

MAC execution unit 205 for one embodiment may be implemented using one or more MAC execution unit building blocks. A MAC execution unit building block may have any suitable number of inputs to receive fetched input data and/or saved input data, may comprise any suitable number of one or more MACs, such as single MAC 300 for example, may comprise any suitable number of one or more buffers to save input data for re-use, and may have any suitable number of outputs to output accumulated data and/or saved input data.

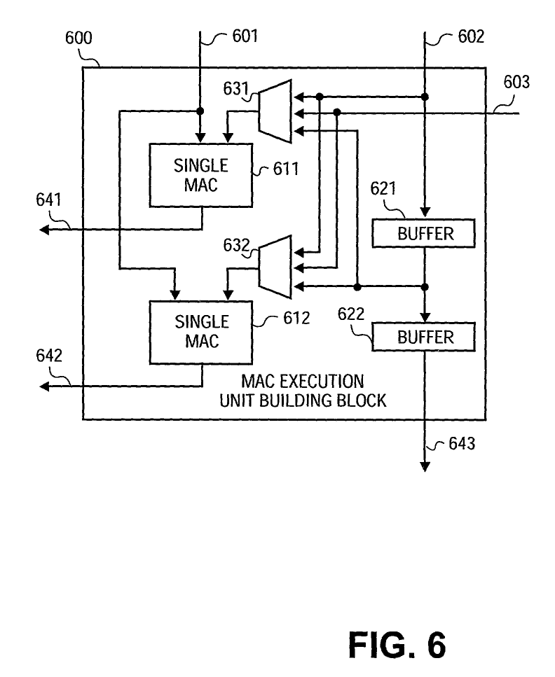

FIG. 6 illustrates, for one embodiment, a MAC execution unit building block 600 comprising single MACs 611 and 612, buffers 621 and 622, and multiplexers 631 and 632.

MAC execution unit building block 600 has inputs 601 and 602 to receive fetched or saved first input data and second input data, respectively. MAC execution unit building block 600 also has input 603 to receive, for example, fetched input data input to another MAC execution unit building block or saved input data from another MAC execution unit building block.

Single MAC 611 is coupled to receive the first input data from input 601 and input data selectively output from multiplexer 631 to perform a multiply-accumulate operation on the first input data and the input data output from multiplexer 631. Single MAC 612 is coupled to receive the first input data from input 601 and input data selectively output from multiplexer 632 to perform a multiply-accumulate operation on the first input data and the input data output from multiplexer 632. Single MACs 611 and 612 for one embodiment may each be similar to single MAC 300 as illustrated in FIG. 3.

Each multiplexer 631 and 632 is coupled to receive as inputs the second input data from input 602, any input data from input 603, and any saved input data output from buffer 621 and selectively outputs the input data received for one of these inputs.

Buffer 621 is coupled to receive the second input data from input 602. Buffer 621 saves or stores the second input data and outputs saved second input data to each multiplexer 631 and 632. Buffer 622 is coupled to receive the saved second input data output from buffer 621. Buffer 622 saves or stores the saved second input data and possibly outputs the saved second input data to a MAC of another MAC execution unit building block, for example.

MAC execution unit building block 600 has outputs 641 and 642 coupled to output first and second accumulated data, respectively, from single MACs 611 and 612, respectively. For another embodiment, MAC execution unit building block 600 may have an output common to both single MACs 611 and 612. MAC execution unit building block 600 also has an output 643 coupled to output saved input data from buffer 622 to another MAC execution unit building block, for example.

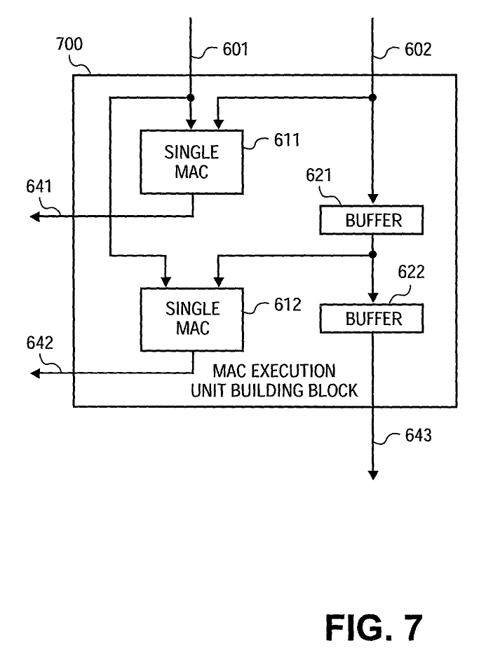

FIG. 7 illustrates, for another embodiment, a MAC execution unit building block 700. MAC execution unit building block 700 is similar to MAC execution unit building block 600. MAC execution unit building block 700 provides fixed couplings in place of multiplexers 631 and 632. Single MAC 611 is coupled to receive the first and second input data to perform a multiply-accumulate operation on the first and second input data. Single MAC 612 is coupled to receive the first input data and to receive saved second input data that was previously input and stored in buffer 621 to perform a multiply-accumulate operation on the first input data and saved second input data. MAC execution unit building block 700 for other embodiments may provide other suitable fixed couplings in place of multiplexer 631 and/or 632.

MAC execution unit 205 may have any suitable number of one or more inputs to receive fetched input data, may have any suitable number of one or more outputs to output accumulated data, and may comprise any suitable number of one or more MAC execution unit building blocks, such as MAC execution unit building block 600 and/or 700 for example, coupled in any suitable manner to receive input data at one or more inputs of MAC execution unit 205 and to output accumulated data at one or more outputs of MAC execution unit 205.

MAC execution unit 205 for one embodiment, as illustrated in FIG. 4, may be implemented with one MAC execution unit building block similar to MAC execution unit building block 700. MAC execution unit 205 for another embodiment may be implemented by combining two MAC execution unit building blocks: one having a single MAC and a single buffer and another one having a single MAC and a single buffer.

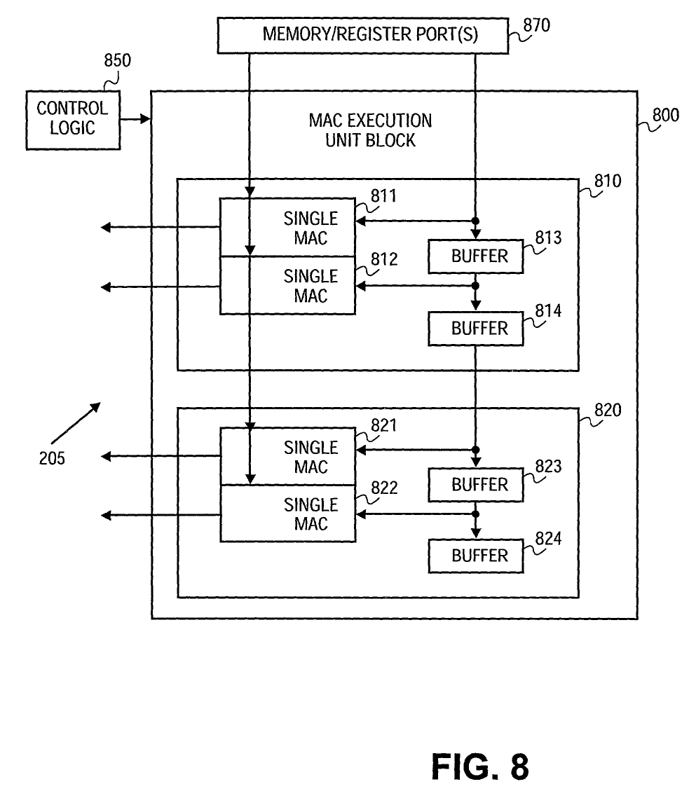

MAC execution unit 205 for another embodiment, as illustrated in FIG. 8, may be implemented with two MAC execution unit building blocks 810 and 820 each similar to MAC execution unit building block 700. As illustrated in FIG. 8, MAC execution unit 205 comprises a MAC execution unit block 800 and control logic 850. Control logic 850 for one embodiment may control MAC execution unit block 800 in accordance with one or more MAC SIMD instructions, for example.

MAC execution unit block 800 comprises MAC execution unit building blocks 810 and 820. MAC execution unit building block 810 is coupled to receive fetched first and second input data from one or more memory or register ports 870. MAC execution unit building block 820 is coupled to receive the fetched first input data from one or more memory or register ports 870 and saved input data from MAC execution unit building block 810.

A single MAC 811 of MAC execution unit building block 810 is coupled to perform a multiply-accumulate operation on the fetched first and second input data. A single MAC 812 of MAC execution unit building block 810 is coupled to perform a multiply-accumulate operation on the fetched first input data and on saved second input data input one computation cycle ago and stored in a buffer 813 of MAC execution unit building block 810.

A single MAC 821 of MAC execution unit building block 820 is coupled to perform a multiply-accumulate operation on the fetched first input data and on saved second input data input two computation cycles ago and stored in a buffer 814 of MAC execution unit building block 810. A single MAC 822 of MAC execution unit building block 820 is coupled to perform a multiply-accumulate operation on the fetched first input data and on saved second input data input three computation cycles ago and stored in a buffer 823 of MAC execution unit building block 820. Any data stored in an additional buffer 824 of MAC execution unit building block 820 for one embodiment may not be used.

MAC execution unit building block 810 for one embodiment may be implemented by combining two smaller MAC execution unit building blocks: one having single MAC 811 and buffer 813 and one having single MAC 812 and buffer 814. MAC execution unit building block 820 for one embodiment may be implemented by combining two smaller MAC execution unit building blocks: one having single MAC 821 and buffer 823 and one having single MAC 822 and buffer 824.

MAC execution unit 205 of FIG. 8 for one embodiment may use only two input data to perform four multiply-accumulate operations for a computation cycle.

MAC execution unit 205 of FIG. 8 may be used, for example, to help compute one or more FIR digital filter output data samples in accordance with the above FIR digital filter Equation 1. MAC execution unit 205 of FIG. 8 may be used to compute one tap per computation cycle on four output data samples.

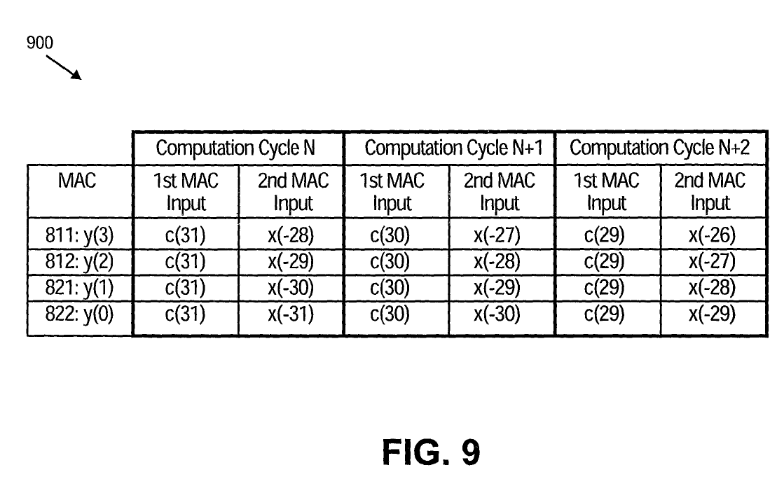

Given a filter length of L=32, for example, MAC execution unit 205 of FIG. 8 may be used to compute, for example, output data samples y(3), y(2), y(1), and y(0) with single MACs 811, 812, 821, and 822, respectively, in accordance with a table 900 of FIG. 9.

As illustrated in FIG. 9, one fetched input data sample is input for each computation cycle N, N+1, N+2, etc. The input data sample is saved for re-use for each of the next three computation cycles. As one example, input data sample x(−28) is input for computation cycle N and saved for re-use for computation cycles N+1, N+2, and N+3. For each computation cycle N, N+1, N+2, etc., three input data samples are saved for re-use for the next computation cycle.

One fetched tap coefficient is input for each computation cycle N, N+1, N+2, etc. Tap coefficients for one embodiment may not be saved by MAC execution unit 205 for re-use but rather may be re-input when computing another set of output data samples, such as output data samples y(7), y(6), y(5), and y(4) for example, with single MACs 811, 812, 821, and 822, respectively.

Although illustrated in FIGS. 4 and 8 as being implemented with one or more MAC execution unit building blocks providing fixed couplings to input data to one or more MACs, MAC execution unit 205 for other embodiments may be similarly implemented with one or more MAC execution unit building blocks similar to MAC execution unit building block 600, that is with one or more MAC execution unit building blocks comprising one or more multiplexers in place of one or more fixed couplings to input data to one or more MACs selectively. MAC execution unit 205 for one embodiment may comprise suitable control logic to control each multiplexer in accordance with one or more MAC SIMD instructions, for example.

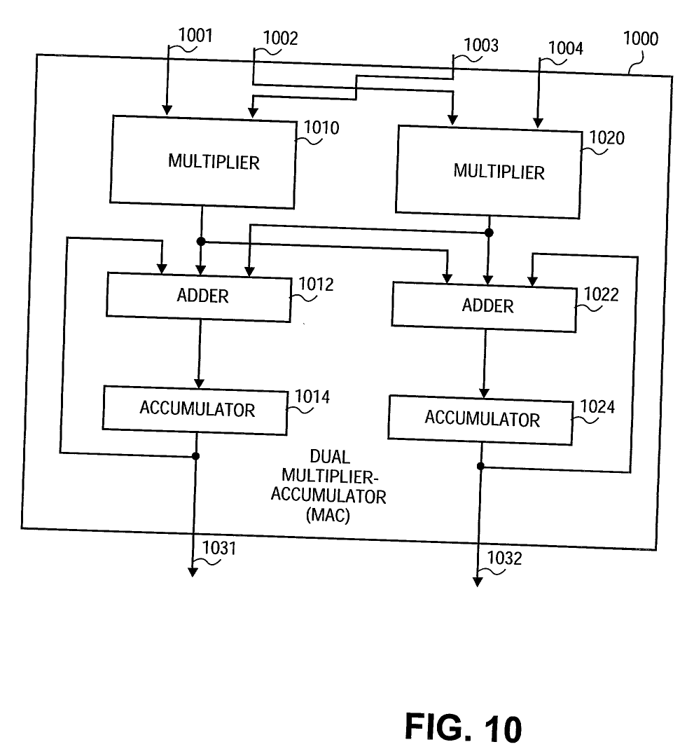

MAC execution unit 205 for another embodiment may be implemented using a dual MAC 1000, as illustrated in FIG. 10, as a basic building block. Dual MAC 1000 for one embodiment may perform two multiply-accumulate operations in one computation cycle and therefore help accelerate the performance of multiple multiply-accumulate operations relative to single MAC 300, for example.

Dual MAC 1000 has a first input 1001 to receive first input data, a second input 1002 to receive second input data, a third input 1003 to receive third input data, and a fourth input 1004 to receive fourth input data. Dual MAC 1000 comprises a multiplier 1010, an adder 1012, an accumulator 1014, a multiplier 1020, an adder 1022, and an accumulator 1024.

Multiplier 1010 is coupled to receive as inputs the first and third input data and may multiply the first and third input data to produce and output a product. Multiplier 1020 is coupled to receive as inputs the second and fourth input data and may multiply the second and fourth input data to produce and output a product.

Adder 1012 is coupled to receive as inputs the product output from multiplier 1010, the product output from multiplier 1020, and/or an accumulated sum stored in accumulator 1014. Adder 1012 may then add any two or all three inputs to produce and output a sum. Accumulator 1014 is coupled to receive and store the sum output from adder 1012. Accumulator 1014 is also coupled to output the accumulated sum stored in accumulator 1014 at an output 1031 of dual MAC 1000.

Adder 1022 is coupled to receive as inputs the product output from multiplier 1010, the product output from multiplier 1020, and/or an accumulated sum stored in accumulator 1024. Adder 1022 may then add any two or all three inputs to produce and output a sum. Accumulator 1024 is coupled to receive and store the sum output from adder 1022. Accumulator 1024 is also coupled to output the accumulated sum stored in accumulator 1024 at an output 1032 of dual MAC 1000.

Multipliers 1010 and 1020 and adders 1012 and 1022 may operate on data of any suitable size, and accumulators 1014 and 1024 may store data of any suitable size. Multipliers 1010 and 1020, adders 1012 and 1022, and accumulators 1014 and 1024 for one embodiment are designed such that dual MAC 1000 may operate on 16-bit input data, for example. Adder 1012, adder 1022, accumulator 1014, and/or accumulator 1024 for one embodiment may support larger precision data, such as 32-bit data for example.

Dual MAC 1000 for one embodiment comprises both adders 1012 and 1022 and both accumulators 1014 and 1024 to allow one or both products output from multipliers 1010 and 1020 to be added to an accumulated sum in one accumulator 1014 or 1024 while an accumulated sum stored in the other accumulator 1014 or 1024 may be output. Dual MAC 1000 for another embodiment may not comprise, for example, adder 1022 and accumulator 1024.

Dual MAC 1000 for one embodiment may comprise suitable circuitry to convert the value of the first input data, the value of the third input data, or the product produced by multiplier 1010 to its additive inverse. In this manner, adder 1012 may effectively subtract the product of the first input data and the third input data from the value of the data stored in accumulator 1014. Dual MAC 1000 for one embodiment may comprise suitable circuitry to allow dual MAC 1000 to be selectively controlled either to add the product of the first input data and the third input data to the value of the data stored in accumulator 1014 or to subtract the product of the first input data and the third input data from the value of the data stored in accumulator 1014.

Dual MAC 1000 for one embodiment may comprise suitable circuitry to convert the value of the second input data, the value of the fourth input data, or the product produced by multiplier 1020 to its additive inverse. In this manner, adder 1022 may effectively subtract the product of the second input data and the fourth input data from the value of the data stored in accumulator 1024. Dual MAC 1000 for one embodiment may comprise suitable circuitry to allow dual MAC 1000 to be selectively controlled either to add the product of the second input data and the fourth input data to the value of the data stored in accumulator 1024 or to subtract the product of the second input data and the fourth input data from the value of the data stored in accumulator 1024.

Dual MAC 1000 for another embodiment may comprise a subtractor in addition to adder 1012 to subtract the product output from multiplier 1010 and/or the product output from multiplier 1020 from the value of the data stored in accumulator 1014 and to output the result to accumulator 1014. Dual MAC 1000 for one embodiment may comprise suitable circuitry to allow dual MAC 1000 to be selectively controlled to add the product of the first input data and the third input data to the value of the data stored in accumulator 1014 and/or to subtract the product of the first input data and the third input data from the value of the data stored in accumulator 1014. Dual MAC 1000 for one embodiment may comprise suitable circuitry to allow dual MAC 1000 to be selectively controlled to add the product of the second input data and the fourth input data to the value of the data stored in accumulator 1014 and/or to subtract the product of the second input data and the fourth input data from the value of the data stored in accumulator 1014.

Dual MAC 1000 for another embodiment may comprise a subtractor in addition to adder 1022 to subtract the product output from multiplier 1010 and/or the product output from multiplier 1020 from the value of the data stored in accumulator 1024 and to output the result to accumulator 1024. Dual MAC 1000 for one embodiment may comprise suitable circuitry to allow dual MAC 1000 to be selectively controlled to add the product of the first input data and the third input data to the value of the data stored in accumulator 1024 and/or to subtract the product of the first input data and the third input data from the value of the data stored in accumulator 1024. Dual MAC 1000 for one embodiment may comprise suitable circuitry to allow dual MAC 1000 to be selectively controlled to add the product of the second input data and the fourth input data to the value of the data stored in accumulator 1024 and/or to subtract the product of the second input data and the fourth input data from the value of the data stored in accumulator 1024.

Dual MAC 1000 for another embodiment may comprise a subtractor instead of adder 1012 to subtract the product output from multiplier 1010 and/or the product output from multiplier 1020 from the value of the data stored in accumulator 1014 and to output the result to accumulator 1014. Dual MAC 1000 for another embodiment may comprise a subtractor instead of adder 1022 to subtract the product output from multiplier 1010 and/or the product output from multiplier 1020 from the value of the data stored in accumulator 1024 and to output the result to accumulator 1024.

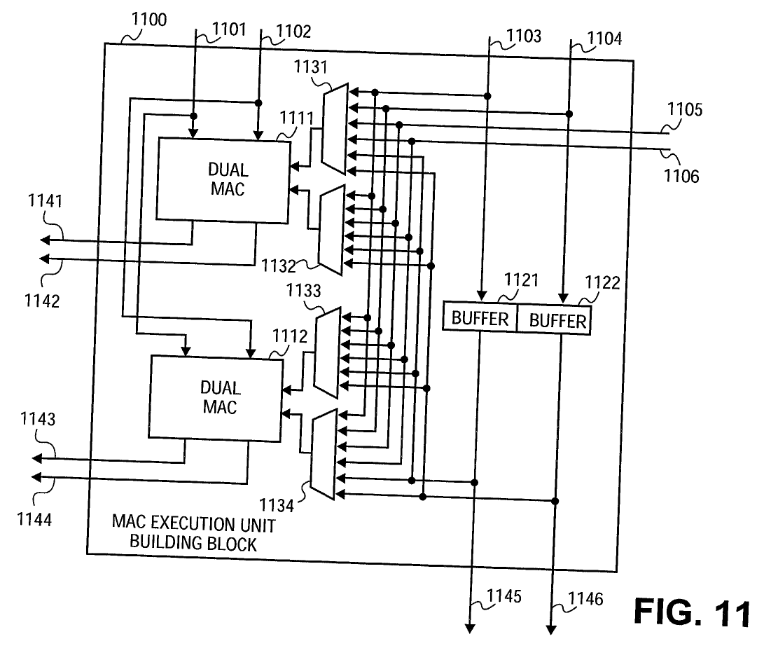

FIG. 11 illustrates, for one embodiment, a MAC execution unit building block 1100 comprising dual MACs 1111 and 1112, buffers 1121 and 1122, and multiplexers 1131, 1132, 1133, and 1134.

MAC execution unit building block 1100 has inputs 1101, 1102, 1103, and 1104 to receive fetched or saved first input data, second input data, third input data, and fourth input data, respectively. MAC execution unit building block 1100 also has inputs 1105 and 1106 to receive, for example, fetched input data input to another MAC execution unit building block or saved input data from another MAC execution unit building block.

Dual MAC 1111 is coupled to receive the first and second input data from inputs 1101 and 1102, respectively, and input data selectively output from multiplexers 1131 and 1132 to perform a multiply-accumulate operation on the first input data and the input data output from multiplexer 1131 and a multiply-accumulate operation on the second input data and the input data output from multiplexer 1132. Dual MAC 1112 is coupled to receive the first and second input data from inputs 1101 and 1102, respectively, and input data selectively output from multiplexers 1133 and 1134 to perform a multiply-accumulate operation on the first input data and the input data output from multiplexer 1133 and a multiply-accumulate operation on the second input data and the input data output from multiplexer 1134. Dual MACs 1111 and 1112 for one embodiment may each be similar to dual MAC 1000 as illustrated in FIG. 10.

Each multiplexer 1131, 1132, 1133, and 1134 is coupled to receive as inputs the third and fourth input data from inputs 1103 and 1104, respectively, any input data from inputs 1105 and 1106, and any saved input data output from buffer 1121 and 1122 and selectively outputs the input data received for one of these inputs.

Buffers 1121 and 1122 are coupled to receive the third and fourth input data, respectively, from inputs 1103 and 1104, respectively. Buffers 1121 and 1122 save or store the third and fourth input data, respectively, and output saved third and fourth input data, respectively, to each multiplexer 1131, 1132, 1133, and 1134 and possibly to one or more other MAC execution unit building blocks, for example.

MAC execution unit building block 1100 has outputs 1141, 1142, 1143, and 1144 coupled to output first, second, third, and fourth accumulated data, respectively, from two accumulators of dual MAC 1111 and from two accumulators of dual MAC 1112. For another embodiment, MAC execution unit building block 1100 may have one output common to the accumulators of dual MAC 1111 and one output common to the accumulators of dual MAC 1112. For another embodiment, MAC execution unit building block 1100 may have one output common to the accumulators of both dual MACs 1111 and 1112. MAC execution unit building block 1100 also has outputs 1145 and 1146 coupled to output saved third and fourth input data, respectively, from buffers 1121 and 1122, respectively, to one or more other MAC execution unit building blocks, for example.

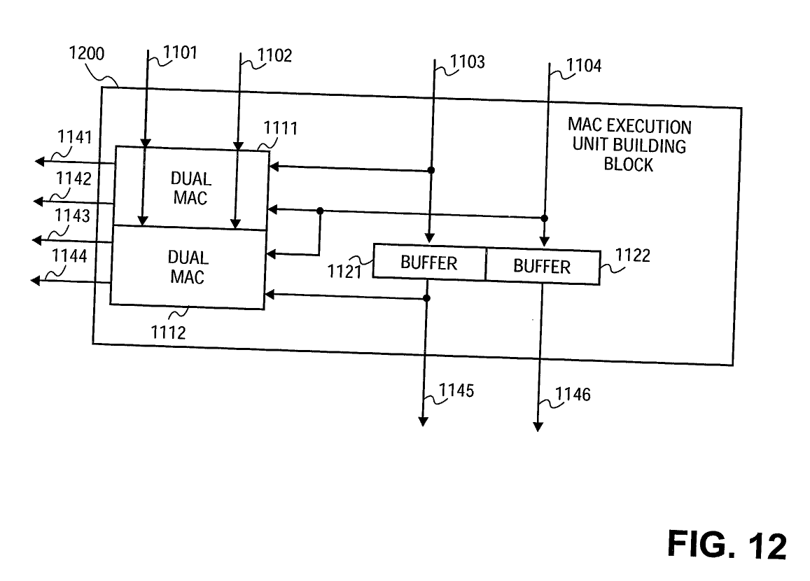

FIG. 12 illustrates, for another embodiment, a MAC execution unit building block 1200. MAC execution unit building block 1200 is similar to MAC execution unit building block 1100. MAC execution unit building block 1200 provides fixed couplings in place of multiplexers 1131, 1132, 1133, and 1134. Dual MAC 1111 is coupled to receive the first, second, third, and fourth input data to perform a multiply-accumulate operation on the first and third input data and a multiply-accumulate operation on the second and fourth input data. Dual MAC 1112 is coupled to receive the first, second, and fourth input data and to receive saved third input data that was previously input and stored in buffer 1121 to perform a multiply-accumulate operation on the first and fourth input data and a multiply-accumulate operation on the second and saved third input data. MAC execution unit building block 1200 for other embodiments may provide other suitable fixed couplings in place of multiplexer 1131, 1132, 1133, and/or 1134.

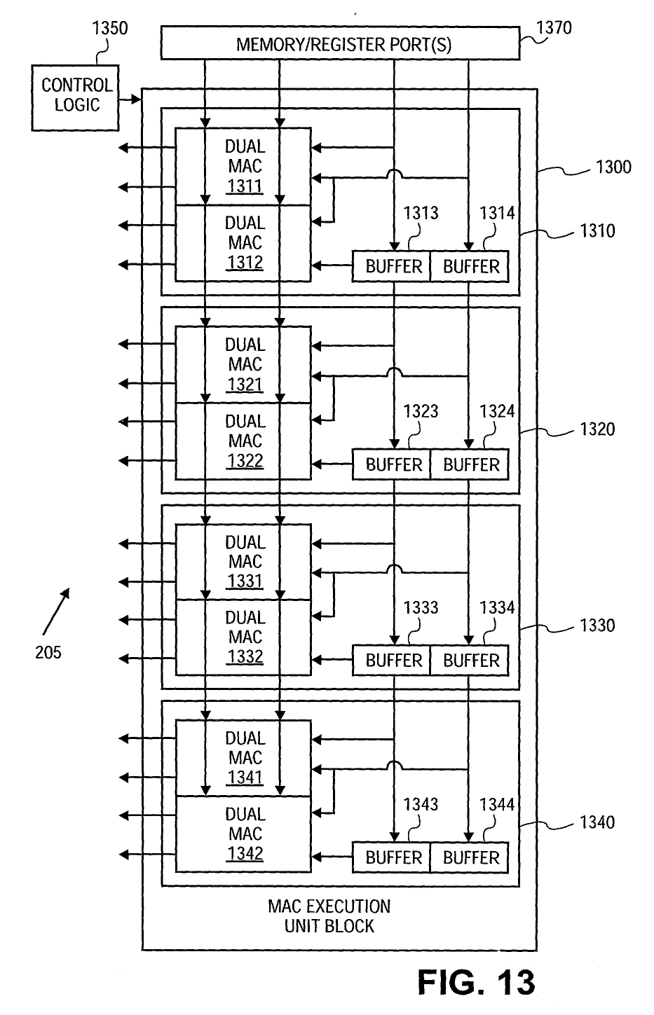

### FIG. 13 Example

MAC execution unit 205 for one embodiment, as illustrated in FIG. 13, may be implemented with four MAC execution unit building blocks 1310, 1320, 1330, and 1340 each similar to MAC execution unit building block 1200. As illustrated in FIG. 13, MAC execution unit 205 comprises a MAC execution unit block 1300 and control logic 1350. Control logic 1350 for one embodiment may control MAC execution unit block 1300 in accordance with one or more MAC SIMD instructions, for example.

MAC execution unit block 1300 comprises MAC execution unit building blocks 1310, 1320, 1330, and 1340. MAC execution unit building block 1310 is coupled to receive fetched first, second, third, and fourth input data from one or more memory or register ports 1370. MAC execution unit building block 1320 is coupled to receive the fetched first and second input data from one or more memory or register ports 1370 and saved input data from MAC execution unit building block 1310. MAC execution unit building block 1330 is coupled to receive the fetched first and second input data from one or more memory or register ports 1370 and saved input data from MAC execution unit building block 1320. MAC execution unit building block 1340 is coupled to receive the fetched first and second input data from one or more memory or register ports 1370 and saved input data from MAC execution unit building block 1330.

A dual MAC 1311 of MAC execution unit building block 1310 is coupled to perform a multiply-accumulate operation on the fetched first and third input data and a multiply-accumulate operation on the fetched second and fourth input data. A dual MAC 1312 of MAC execution unit building block 1310 is coupled to perform a multiply-accumulate operation on the fetched first and fourth input data and a multiply-accumulate operation on the fetched second input data and on saved third input data input one computation cycle ago and stored in a buffer 1313 of MAC execution unit building block 1310.

A dual MAC 1321 of MAC execution unit building block 1320 is coupled to perform a multiply-accumulate operation on the fetched first input data and on the saved third input data stored in buffer 1313 and a multiply-accumulate operation on the fetched second input data and on saved fourth input data input one computation cycle ago and stored in a buffer 1314 of MAC execution unit building block 1310. A dual MAC 1322 of MAC execution unit building block 1320 is coupled to perform a multiply-accumulate operation on the fetched first input data and on the saved fourth input data stored in buffer 1314 and a multiply-accumulate operation on the fetched second input data and on saved third input data input two computation cycles ago and stored in a buffer 1323 of MAC execution unit building block 1320.

A dual MAC 1331 of MAC execution unit building block 1330 is coupled to perform a multiply-accumulate operation on the fetched first input data and on the saved third input data stored in buffer 1323 and a multiply-accumulate operation on the fetched second input data and on saved fourth input data input two computation cycles ago and stored in a buffer 1324 of MAC execution unit building block 1320. A dual MAC 1332 of MAC execution unit building block 1330 is coupled to perform a multiply-accumulate operation on the fetched first input data and on the saved fourth input data stored in buffer 1324 and a multiply-accumulate operation on the fetched second input data and on saved third input data input three computation cycles ago and stored in a buffer 1333 of MAC execution unit building block 1330.

A dual MAC 1341 of MAC execution unit building block 1340 is coupled to perform a multiply-accumulate operation on the fetched first input data and on the saved third input data stored in buffer 1333 and a multiply-accumulate operation on the fetched second input data and on saved fourth input data input three computation cycles ago and stored in a buffer 1334 of MAC execution unit building block 1330. A dual MAC 1342 of MAC execution unit building block 1340 is coupled to perform a multiply-accumulate operation on the fetched first input data and on the saved fourth input data stored in buffer 1334 and a multiply-accumulate operation on the fetched second input data and on saved third input data input four computation cycles ago and stored in a buffer 1343 of MAC execution unit building block 1340. Any data stored in an additional buffer 1344 of MAC execution unit building block 1340 for one embodiment may not be used.

MAC execution unit 205 of FIG. 13 for one embodiment may use only four input data to perform sixteen multiply-accumulate operations for a computation cycle.

MAC execution unit 205 of FIG. 13 may be used, for example, to help compute one or more FIR digital filter output data samples in accordance with the above FIR digital filter Equation 1. MAC execution unit 205 of FIG. 13 may be used to compute two taps per computation cycle on eight output data samples.

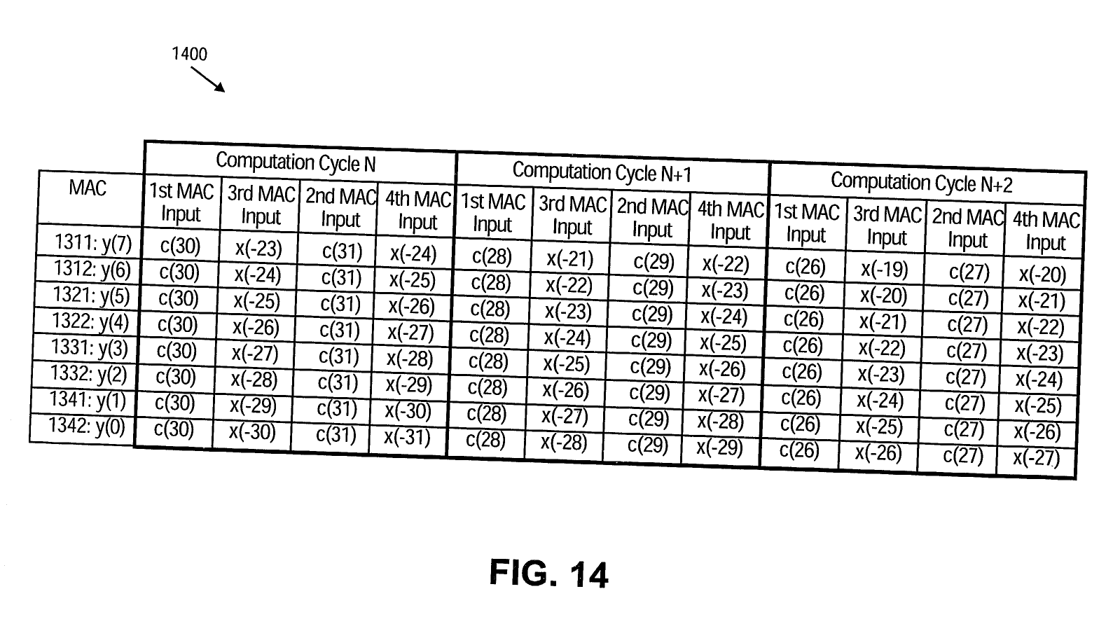

Given a filter length of L=32, for example, MAC execution unit 205 of FIG. 13 may be used to compute, for example, output data samples y(7), y(6), y(5), y(4), y(3), y(2), y(1), and y(0) with dual MACs 1311, 1312, 1321, 1322, 1331, 1332, 1341, and 1342, respectively, in accordance with a table 1400 of FIG. 14.

As illustrated in FIG. 14, two fetched input data samples are input for each computation cycle N, N+1, N+2, etc. The first input data sample is saved for re-use for each of the next four computation cycles. The second input data sample is saved for re-use for each of the next three computation cycles. As one example, input data samples x(−23) and x(−24) are input for computation cycle N and saved for re-use for computation cycles N+1, N+2, and N+3. Input data sample x(−23) is also saved for re-use for computation cycle N+4. For each computation cycle N, N+1, N+2, etc., seven input data samples are saved for re-use for the next computation cycle.

Two fetched tap coefficients are input for each computation cycle N, N+1, N+2, etc. Tap coefficients for one embodiment may not be saved by MAC execution unit 205 for re-use but rather may be re-input when computing another set of output data samples, such as output data samples y(15), y(14), y(13), y(12), y(11), y(10), y(9), and y(8) for example, with dual MACs 1311, 1312, 1321, 1322, 1331, 1332, 1341, and 1342, respectively.

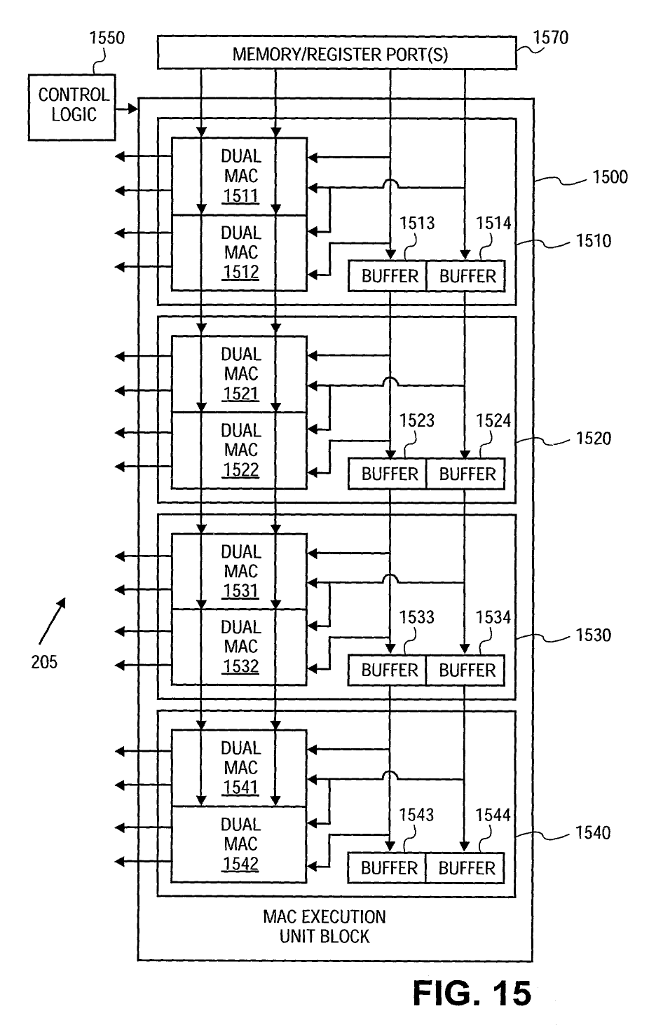

### FIG. 15 Example

MAC execution unit 205 for another embodiment, as illustrated in FIG. 15, may be implemented with four MAC execution unit building blocks 1510, 1520, 1530, and 1540. As illustrated in FIG. 15, MAC execution unit 205 comprises a MAC execution unit block 1500 and control logic 1550. Control logic 1550 for one embodiment may control MAC execution unit block 1500 in accordance with one or more MAC SIMD instructions, for example.

MAC execution unit block 1500 comprises MAC execution unit building blocks 1510, 1520, 1530, and 1540. MAC execution unit building block 1510 is coupled to receive fetched first, second, third, and fourth input data from one or more memory or register ports 1570. MAC execution unit building block 1520 is coupled to receive the fetched first and second input data from one or more memory or register ports 1570 and saved input data from MAC execution unit building block 1510. MAC execution unit building block 1530 is coupled to receive the fetched first and second input data from one or more memory or register ports 1570 and saved input data from MAC execution unit building block 1520. MAC execution unit building block 1540 is coupled to receive the fetched first and second input data from one or more memory or register ports 1570 and saved input data from MAC execution unit building block 1530.

A dual MAC 1511 of MAC execution unit building block 1510 is coupled to perform a multiply-accumulate operation on the fetched first and third input data and a multiply-accumulate operation on the fetched second and fourth input data. A dual MAC 1512 of MAC execution unit building block 1510 is coupled to perform a multiply-accumulate operation on the fetched first and fourth input data and a multiply-accumulate operation on the fetched second and third input data.

A dual MAC 1521 of MAC execution unit building block 1520 is coupled to perform a multiply-accumulate operation on the fetched first input data and on saved third input data input one computation cycle ago and stored in a buffer 1513 of MAC execution unit building block 1510. Dual MAC 1521 is also coupled to perform a multiply-accumulate operation on the fetched second input data and on saved fourth input data input one computation cycle ago and stored in a buffer 1514 of MAC execution unit building block 1510. A dual MAC 1522 of MAC execution unit building block 1520 is coupled to perform a multiply-accumulate operation on the fetched first input data and on the saved fourth input data stored in buffer 1514 and a multiply-accumulate operation on the fetched second input data and on the saved third input data stored in buffer 1513.

A dual MAC 1531 of MAC execution unit building block 1530 is coupled to perform a multiply-accumulate operation on the fetched first input data and on saved third input data input two computation cycles ago and stored in a buffer 1523 of MAC execution unit building block 1520. Dual MAC 1531 is also coupled to perform a multiply-accumulate operation on the fetched second input data and on saved fourth input data input two computation cycles ago and stored in a buffer 1524 of MAC execution unit building block 1520. A dual MAC 1532 of MAC execution unit building block 1530 is coupled to perform a multiply-accumulate operation on the fetched first input data and on the saved fourth input data stored in buffer 1524 and a multiply-accumulate operation on the fetched second input data and on the saved third input data stored in buffer 1523.

A dual MAC 1541 of MAC execution unit building block 1540 is coupled to perform a multiply-accumulate operation on the fetched first input data and on saved third input data input three computation cycles ago and stored in a buffer 1533 of MAC execution unit building block 1530. Dual MAC 1541 is also coupled to perform a multiply-accumulate operation on the fetched second input data and on saved fourth input data input two computation cycles ago and stored in a buffer 1534 of MAC execution unit building block 1530. A dual MAC 1542 of MAC execution unit building block 1540 is coupled to perform a multiply-accumulate operation on the fetched first input data and on the saved fourth input data stored in buffer 1534 and a multiply-accumulate operation on the fetched second input data and on the saved third input data stored in buffer 1533. Any data stored in buffers 1543 and/or 1544 of MAC execution unit building block 1540 for one embodiment may not be used.

MAC execution unit 205 of FIG. 15 for one embodiment may use only four input data to perform sixteen multiply-accumulate operations for a computation cycle.

MAC execution unit 205 of FIG. 15 may be used, for example, to help compute one or more FIR digital filter output data samples in accordance with the above FIR digital filter Equation 2 and Equation 3. MAC execution unit 205 of FIG. 15 may be used to compute one complex tap per computation cycle on four complex output data samples.

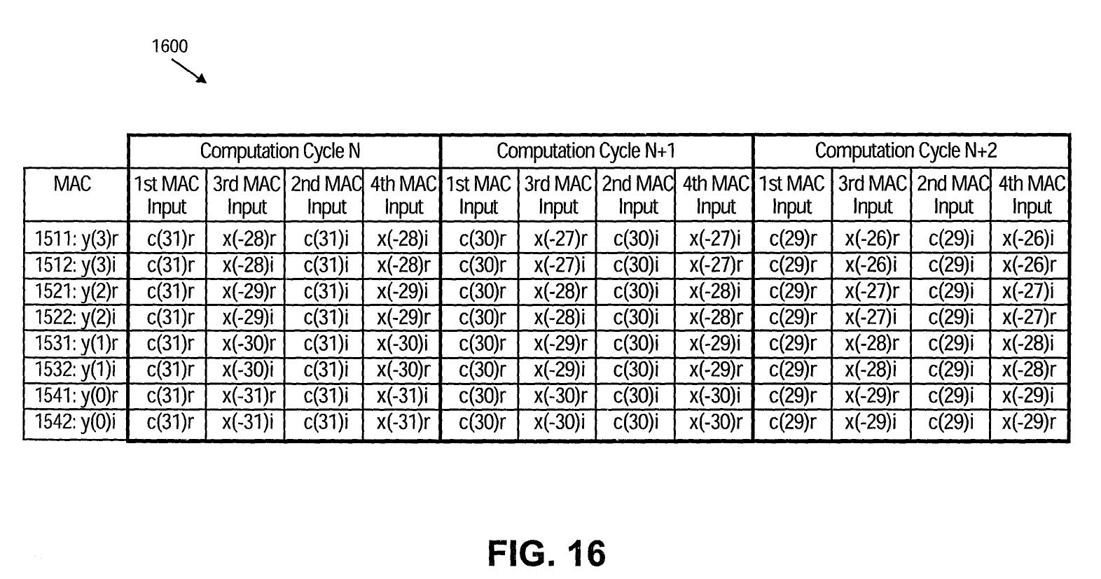

Given a filter length of L=32, for example, MAC execution unit 205 of FIG. 15 may be used to compute, for example, output data samples y(3), y(2), y(1), and y(0) with MAC execution unit building blocks 1510, 1520, 1530, and 1540, respectively, in accordance with a table 1600 of FIG. 16. For this example, dual MACs 1511, 1521, 1531, and 1541 each compute the real component of output data samples y(3), y(2), y(1), and y(0), respectively, and dual MACs 1512, 1522, 1532, and 1542 each compute the imaginary component of output data samples y(3), y(2), y(1), and y(0), respectively.

As illustrated in FIG. 16, real and imaginary component data of one fetched input data sample are input for each computation cycle N, N+1, N+2, etc. The real and imaginary component data are saved for re-use for each of the next three computation cycles. As one example, the real and imaginary component data of input data sample x(−28) are input for computation cycle N and saved for re-use for computation cycles N+1, N+2, and N+3. For each computation cycle N, N+1, N+2, etc., the real and imaginary component data for three input data samples are saved for re-use for the next computation cycle.

Real and imaginary component data of one fetched tap coefficient are input for each computation cycle N, N+1, N+2, etc. Tap coefficients for one embodiment may not be saved by MAC execution unit 205 for re-use but rather may be re-input when computing another set of output data samples, such as output data samples y(7), y(6), y(5), and y(4) for example, with MAC execution unit building blocks 1510, 1520, 1530, and 1540, respectively.

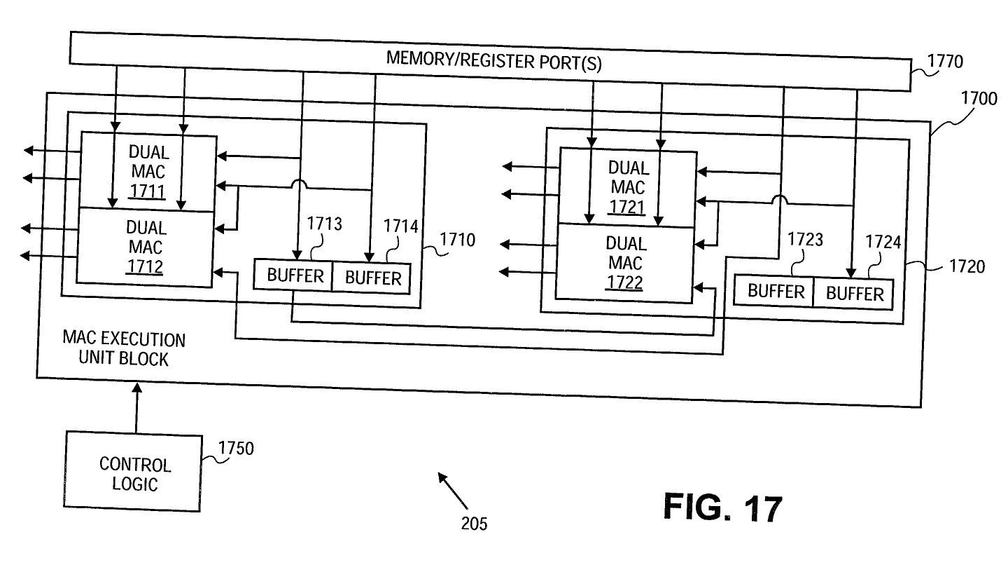

### FIG. 17 Example

MAC execution unit 205 for another embodiment, as illustrated in FIG. 17, may be implemented with two MAC execution unit building blocks 1710 and 1720. As illustrated in FIG. 17, MAC execution unit 205 comprises a MAC execution unit block 1700 and control logic 1750. Control logic 1750 for one embodiment may control MAC execution unit block 1700 in accordance with one or more MAC SIMD instructions, for example.

MAC execution unit block 1700 comprises MAC execution unit building blocks 1710 and 1720. MAC execution unit building block 1710 is coupled to receive fetched first, second, third, fourth, and seventh input data from one or more memory or register ports 1770. MAC execution unit building block 1720 is coupled to receive the fetched seventh input data and fetched fifth, sixth, and eighth input data from one or more memory or register ports 1770 and saved input data from MAC execution unit building block 1710.

A dual MAC 1711 of MAC execution unit building block 1710 is coupled to perform a multiply-accumulate operation on the fetched first and third input data and a multiply-accumulate operation on the fetched second and fourth input data. A dual MAC 1712 of MAC execution unit building block 1710 is coupled to perform a multiply-accumulate operation on the fetched first and fourth input data and a multiply-accumulate operation on the fetched second and seventh input data.

A dual MAC 1721 of MAC execution unit building block 1720 is coupled to perform a multiply-accumulate operation on the fetched fifth and seventh input data and a multiply-accumulate operation on the fetched sixth and eighth input data. A dual MAC 1722 of MAC execution unit building block 1720 is coupled to perform a multiply-accumulate operation on the fetched fifth and eighth input data and a multiply-accumulate operation on the fetched sixth input data and on saved third input data input one computation cycle ago and stored in a buffer 1713 of MAC execution unit building block 1710. Any data stored in an additional buffer 1714 of MAC execution unit building block 1710 and/or in buffers 1723 and/or 1724 of MAC execution unit building block 1720 for one embodiment may not be used.

MAC execution unit 205 of FIG. 17 for one embodiment may use only eight input data to perform eight multiply-accumulate operations for a computation cycle.

MAC execution unit 205 of FIG. 17 may be used, for example, to help compute one or more FIR digital filter output data samples in accordance with the above FIR digital filter Equation 1. MAC execution unit 205 of FIG. 17 may be used to compute four taps per computation cycle on two output data samples.

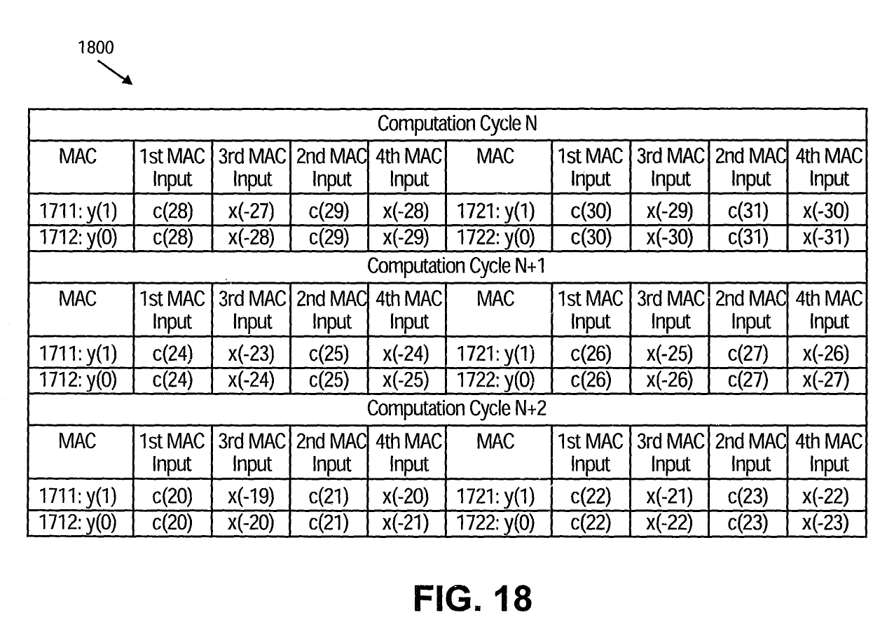

Given a filter length of L=32, for example, MAC execution unit 205 of FIG. 17 may be used to compute, for example, output data sample y(1) with dual MACs 1711 and 1721 and output data sample y(0) with dual MACs 1712 and 1722, in accordance with a table 1800 of FIG. 18. As two dual MACs are used for each output data sample for one embodiment, the resulting accumulated sums computed by the two dual MACs may be added by execution logic 204, for example, to compute the output data sample.

As illustrated in FIG. 18, four fetched input data samples are input for each computation cycle N, N+1, N+2, etc. The first input data sample is saved for re-use for the next computation cycle. As one example, input data sample x(−27) is saved for re-use for computation cycle N+1. For each computation cycle N, N+1, N+2, etc., one input data sample is saved for re-use for the next computation cycle.

Four fetched tap coefficients are input for each computation cycle N, N+1, N+2, etc. Tap coefficients for one embodiment may not be saved by MAC execution unit 205 for re-use but rather may be re-input when computing another set of output data samples, such as output data samples y(3) and y(2) for example, with dual MACs 1711, 1712, 1721, and 1722.

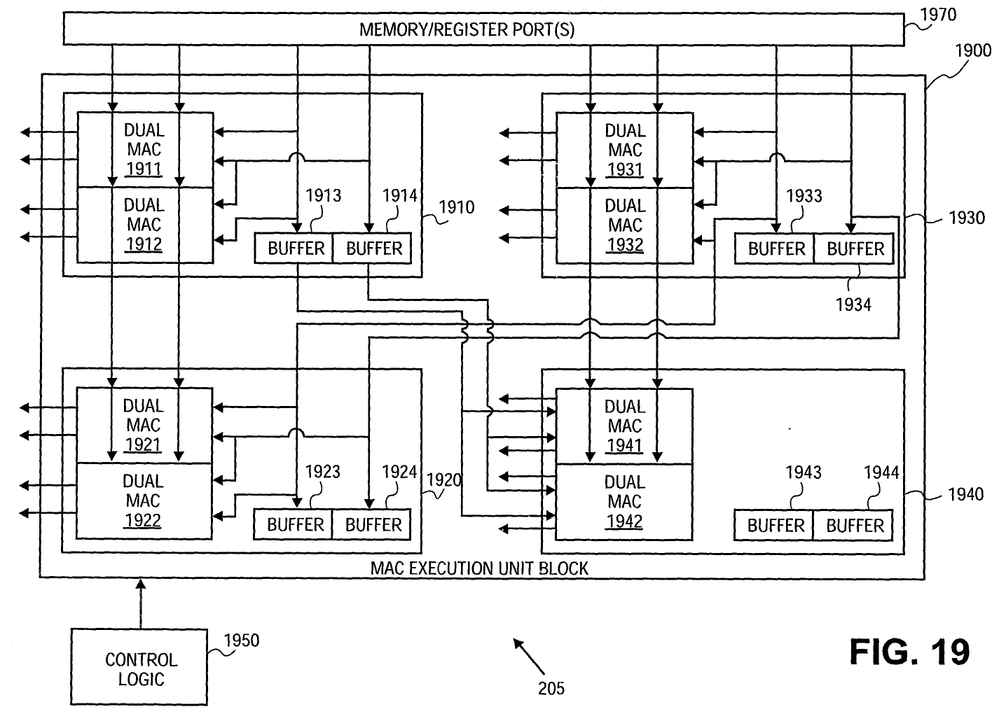

### FIG. 19 Example

MAC execution unit 205 for another embodiment, as illustrated in FIG. 19, may be implemented with four MAC execution unit building blocks 1910, 1920, 1930, and 1940. As illustrated in FIG. 19, MAC execution unit 205 comprises a MAC execution unit block 1900 and control logic 1950. Control logic 1950 for one embodiment may control MAC execution unit block 1900 in accordance with one or more MAC SIMD instructions, for example.

MAC execution unit block 1900 comprises MAC execution unit building blocks 1910, 1920, 1930, and 1940. MAC execution unit building block 1910 is coupled to receive fetched first, second, third, and fourth input data from one or more memory or register ports 1970. MAC execution unit building block 1920 is coupled to receive the fetched first and second input data and fetched seventh and eighth input data from one or more memory or register ports 1970. MAC execution unit building block 1930 is coupled to receive fetched fifth and sixth input data and the fetched seventh and eighth input data from one or more memory or register ports 1970. MAC execution unit building block 1940 is coupled to receive the fetched fifth and sixth input data from one or more memory or register ports 1970 and saved input data from MAC execution unit building block 1910.

A dual MAC 1911 of MAC execution unit building block 1910 is coupled to perform a multiply-accumulate operation on the fetched first and third input data and a multiply-accumulate operation on the fetched second and fourth input data. A dual MAC 1912 of MAC execution unit building block 1910 is coupled to perform a multiply-accumulate operation on the fetched first and fourth input data and a multiply-accumulate operation on the fetched second and third input data.

A dual MAC 1921 of MAC execution unit building block 1920 is coupled to perform a multiply-accumulate operation on the fetched first and seventh input data and a multiply-accumulate operation on the fetched second and eighth input data. A dual MAC 1922 of MAC execution unit building block 1920 is coupled to perform a multiply-accumulate operation on the fetched first and eighth input data and a multiply-accumulate operation on the fetched second and seventh input data.

A dual MAC 1931 of MAC execution unit building block 1930 is coupled to perform a multiply-accumulate operation on the fetched fifth and seventh input data and a multiply-accumulate operation on the fetched sixth and eighth input data. A dual MAC 1932 of MAC execution unit building block 1930 is coupled to perform a multiply-accumulate operation on the fetched fifth and eighth input data and a multiply-accumulate operation on the fetched sixth and seventh input data.

A dual MAC 1941 of MAC execution unit building block 1940 is coupled to perform a multiply-accumulate operation on the fetched fifth input data and on saved third input data input one computation cycle ago and stored in a buffer 1913 of MAC execution unit building block 1910. Dual MAC 1941 is also coupled to perform a multiply-accumulate operation on the fetched sixth input data and on saved fourth input data input one computation cycle ago and stored in a buffer 1914 of MAC execution unit building block 1910. A dual MAC 1942 of MAC execution unit building block 1940 is coupled to perform a multiply-accumulate operation on the fetched fifth input data and on the saved fourth input data stored in buffer 1914 and a multiply-accumulate operation on the fetched sixth input data and on the saved third input data stored in buffer 1913. Any data stored in buffers 1923 and/or 1924 of MAC execution unit building block 1920, buffers 1933 and/or 1934 of MAC execution unit building block 1930, and/or buffers 1943 and/or 1944 of MAC execution unit building block 1940 for one embodiment may not be used.

MAC execution unit 205 of FIG. 19 for one embodiment may use only eight input data to perform sixteen multiply-accumulate operations for a computation cycle.

MAC execution unit 205 of FIG. 19 may be used, for example, to help compute one or more FIR digital filter output data samples in accordance with the above FIR digital filter Equation 2 and Equation 3. MAC execution unit 205 of FIG. 19 may be used to compute two complex taps per computation cycle on two complex output data samples.

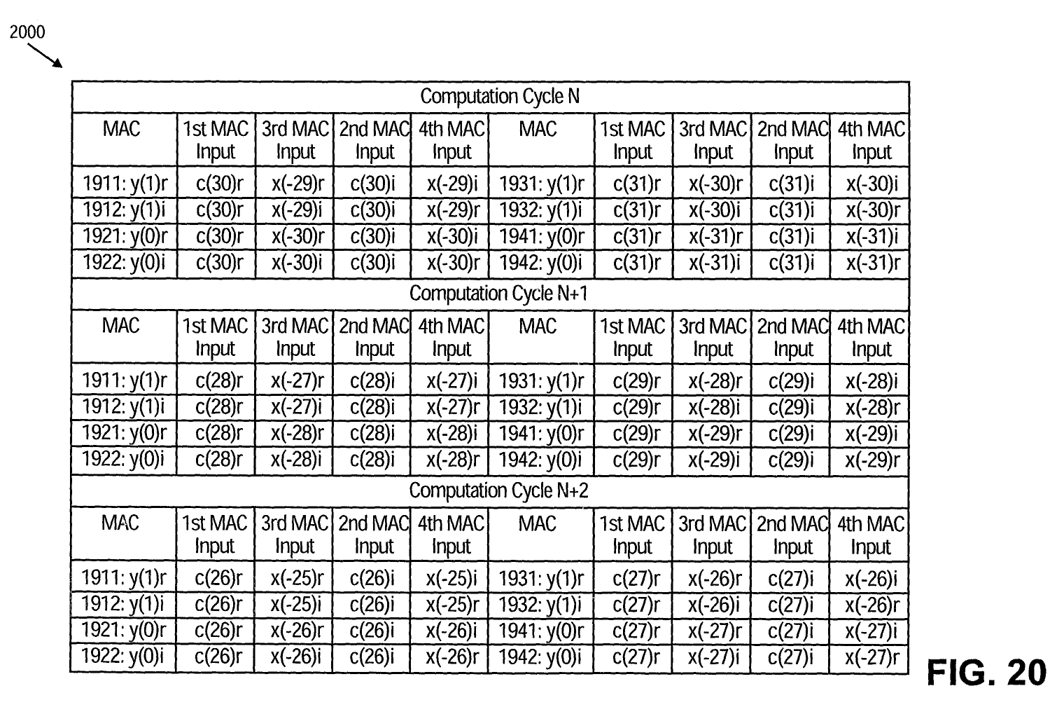

Given a filter length of L=32, for example, MAC execution unit 205 of FIG. 19 may be used to compute, for example, output data sample y(1) with MAC execution unit building blocks 1910 and 1930 and output data sample y(0) with MAC execution unit building blocks 1920 and 1940 in accordance with a table 2000 of FIG. 20. For this example, dual MACs 1911 and 1931 compute the real component of output data sample y(1), dual MACs 1912 and 1932 compute the imaginary component of output data sample y(1), dual MACs 1921 and 1941 compute the real component of output data sample y(1), and dual MACs 1922 and 1942 compute the imaginary component of output data sample y(0). As two dual MACs are used for each component of an output data sample for one embodiment, the resulting accumulated sums computed by the two dual MACs may be added by execution logic 204, for example, to compute the component of the output data sample.

As illustrated in FIG. 20, real and imaginary component data of two fetched input data samples are input for each computation cycle N, N+1, N+2, etc. The real and imaginary component data of the first input data sample are saved for re-use for the next computation cycle. As one example, the real and imaginary component data of input data sample x(−29) are input for computation cycle N and saved for re-use for computation cycle N+1. For each computation cycle N, N+1, N+2, etc., the real and imaginary component data for one input data sample are saved for re-use for the next computation cycle.

Real and imaginary component data of two fetched tap coefficients are input for each computation cycle N, N+1, N+2, etc. Tap coefficients for one embodiment may not be saved by MAC execution unit 205 for re-use but rather may be re-input when computing another set of output data samples, such as output data samples y(3) and y(2) for example, with MAC execution unit building blocks 1910, 1920, 1930, and 1940.

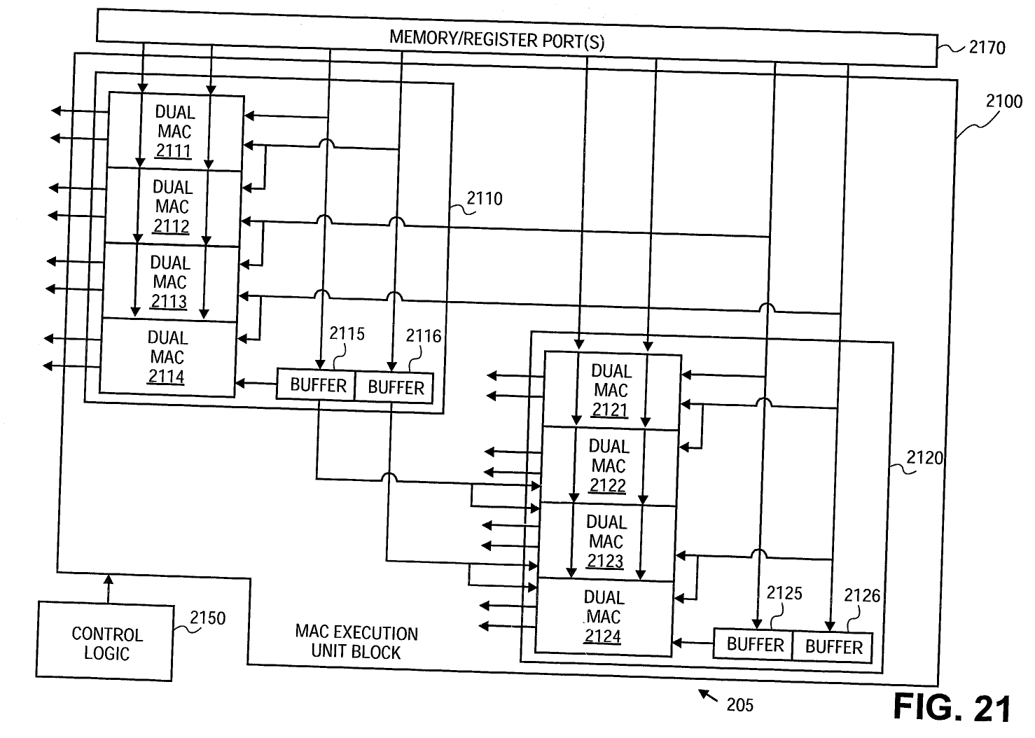

### FIG. 21 Example

MAC execution unit 205 for another embodiment, as illustrated in FIG. 21 may be implemented with two MAC execution unit building blocks 2110 and 2120. As illustrated in FIG. 21, MAC execution unit 205 comprises a MAC execution unit block 2100 and control logic 2150. Control logic 2150 for one embodiment may control MAC execution unit block 2100 in accordance with one or more MAC SIMD instructions, for example.

MAC execution unit block 2100 comprises MAC execution unit building blocks 2110 and 2120. MAC execution unit building block 2110 is coupled to receive fetched first, second, third, fourth, seventh, and eighth input data from one or more memory or register ports 2170. MAC execution unit building block 2120 is coupled to receive the fetched seventh and eighth input data and fetched fifth and sixth input data from one or more memory or register ports 2170 and saved input data from MAC execution unit building block 2110.

A dual MAC 2111 of MAC execution unit building block 2110 is coupled to perform a multiply-accumulate operation on the fetched first and third input data and a multiply-accumulate operation on the fetched second and fourth input data. A dual MAC 2112 of MAC execution unit building block 2110 is coupled to perform a multiply-accumulate operation on the fetched first and fourth input data and a multiply-accumulate operation on the fetched second and seventh input data. A dual MAC 2113 of MAC execution unit building block 2110 is coupled to perform a multiply-accumulate operation on the fetched first and seventh input data and a multiply-accumulate operation on the fetched second and eighth input data. A dual MAC 2114 of MAC execution unit building block 2110 is coupled to perform a multiply-accumulate operation on the fetched first and eighth input data and a multiply-accumulate operation on the fetched second input data and on saved third input data input one computation cycle ago and stored in a buffer 2115 of MAC execution unit building block 2110.

A dual MAC 2121 of MAC execution unit building block 2120 is coupled to perform a multiply-accumulate operation on the fetched fifth and seventh input data and a multiply-accumulate operation on the fetched sixth and eighth input data. A dual MAC 2122 of MAC execution unit building block 2120 is coupled to perform a multiply-accumulate operation on the fetched fifth and eighth input data and a multiply-accumulate operation on the fetched sixth input data and on the saved third input data stored in buffer 2115. A dual MAC 2123 of MAC execution unit building block 2120 is coupled to perform a multiply-accumulate operation on the fetched fifth input data and on the saved third input data stored in buffer 2115 and a multiply-accumulate operation on the fetched sixth input data and on saved fourth input data input one computation cycle ago and stored in a buffer 2116 of MAC execution unit building block 2110. A dual MAC 2124 of MAC execution unit building block 2120 is coupled to perform a multiply-accumulate operation on the fetched fifth input data and on the saved fourth input data stored in buffer 2116 and a multiply-accumulate operation on the fetched sixth input data and on saved seventh input data input one computation cycle ago and stored in a buffer 2125 of MAC execution unit building block 2120. Any data stored in an additional buffer 2126 of MAC execution unit building block 2120 for one embodiment may not be used.

MAC execution unit building block 2110 for one embodiment may be implemented by combining two smaller MAC execution unit building blocks: one having dual MACs 2111 and 2112 and two buffers and one having dual MACs 2113 and 2114 and buffers 2115 and 2116. MAC execution unit building block 2120 for one embodiment may be implemented by combining two smaller MAC execution unit building blocks: one having dual MACs 2121 and 2122 and two buffers and one having dual MACs 2123 and 2124 and buffers 2125 and 2126.

MAC execution unit 205 of FIG. 21 for one embodiment may use only eight input data to perform sixteen multiply-accumulate operations for a computation cycle.

MAC execution unit 205 of FIG. 21 may be used, for example, to help compute one or more FIR digital filter output data samples in accordance with the above FIR digital filter Equation 1. MAC execution unit 205 of FIG. 21 may be used to compute four taps per computation cycle on four output data samples.

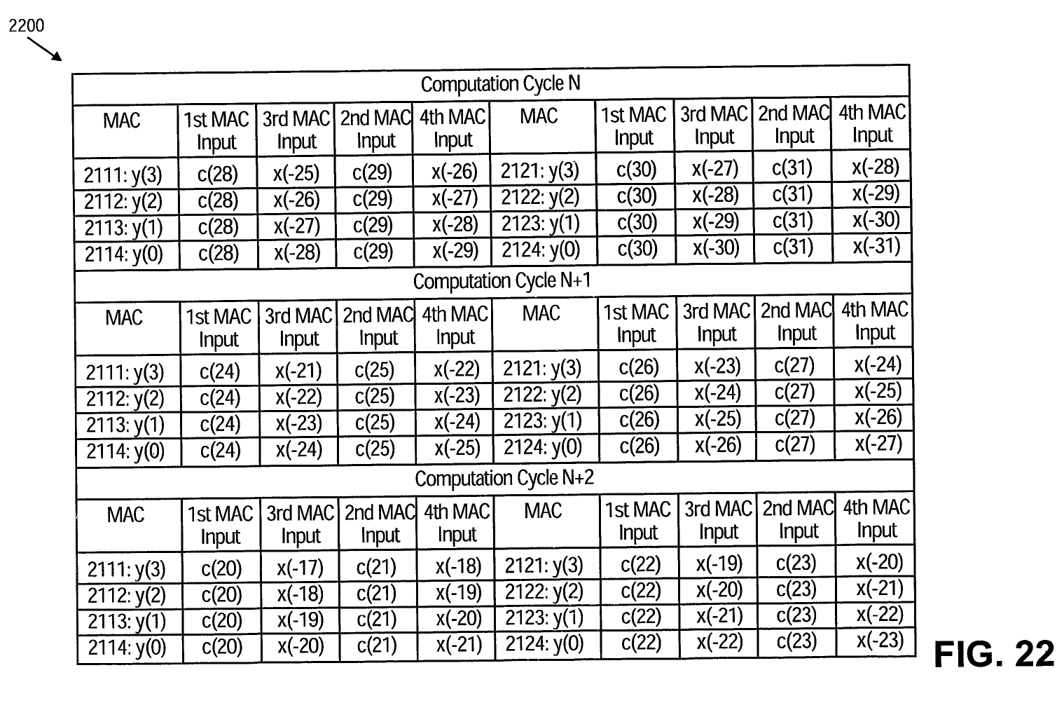

Given a filter length of L=32, for example, MAC execution unit 205 of FIG. 21 may be used to compute, for example, output data sample y(3) with dual MACs 2111 and 2121, output data sample y(2) with dual MACs 2112 and 2122, output data sample y(1) with dual MACs 2113 and 2123, and output data sample y(4) with dual MACs 2114 and 2124 in accordance with a table 2200 of FIG. 22. As two dual MACs are used for each output data sample for one embodiment, the resulting accumulated sums computed by the two dual MACs may be added by execution logic 204, for example, to compute the output data sample.

As illustrated in FIG. 22, four fetched input data samples are input for each computation cycle N, N+1, N+2, etc. The first three input data samples are saved for re-use for the next computation cycle. As one example, input data samples x(−25), x(−26), and x(−27) are saved for re-use for computation cycle N+1. For each computation cycle N, N+1, N+2, etc., three input data samples are saved for re-use for the next computation cycle.

Four fetched tap coefficients are input for each computation cycle N, N+1, N+2, etc. Tap coefficients for one embodiment may not be saved by MAC execution unit 205 for re-use but rather may be re-input when computing another set of output data samples, such as output data samples y(7), y(6), y(5), and y(4) for example, with dual MACs 2111, 2112, 2113, 2114, 2121, 2122, 2123, and 2124.

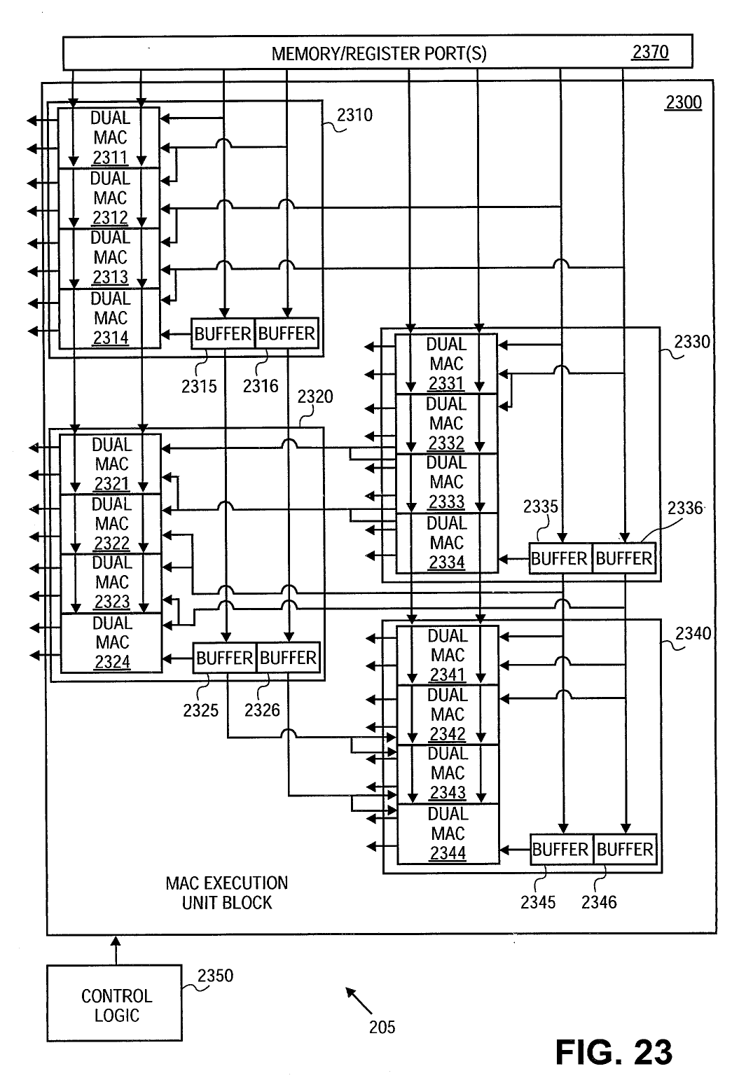

### FIG. 23 Example

MAC execution unit 205 for another embodiment, as illustrated in FIG. 23 may be implemented with four MAC execution unit building blocks 2310, 2320, 2330, and 2340. As illustrated in FIG. 23, MAC execution unit 205 comprises a MAC execution unit block 2300 and control logic 2350. Control logic 2350 for one embodiment may control MAC execution unit block 2300 in accordance with one or more MAC SIMD instructions, for example.

MAC execution unit block 2300 comprises MAC execution unit building blocks 2310, 2320, 2330, and 2340. MAC execution unit building block 2310 is coupled to receive fetched first, second, third, fourth, seventh, and eighth input data from one or more memory or register ports 2370. MAC execution unit building block 2320 is coupled to receive the fetched first and second input data from one or more memory or register ports 2370 and saved input data from MAC execution unit building blocks 2310 and 2330. MAC execution unit building block 2330 is coupled to receive the fetched seventh and eighth input data and fetched fifth and sixth input data from one or more memory or register ports 2370 and saved input data from MAC execution unit building block 2310. MAC execution unit building block 2340 is coupled to receive the fetched fifth and sixth input data from one or more memory or register ports 2370 and saved input data from MAC execution unit building blocks 2320 and 2330.

A dual MAC 2311 of MAC execution unit building block 2310 is coupled to perform a multiply-accumulate operation on the fetched first and third input data and a multiply-accumulate operation on the fetched second and fourth input data. A dual MAC 2312 of MAC execution unit building block 2310 is coupled to perform a multiply-accumulate operation on the fetched first and fourth input data and a multiply-accumulate operation on the fetched second and seventh input data. A dual MAC 2313 of MAC execution unit building block 2310 is coupled to perform a multiply-accumulate operation on the fetched first and seventh input data and a multiply-accumulate operation on the fetched second and eighth input data. A dual MAC 2314 of MAC execution unit building block 2310 is coupled to perform a multiply-accumulate operation on the fetched first and eighth input data and a multiply-accumulate operation on the fetched second input data and on saved third input data input one computation cycle ago and stored in a buffer 2315 of MAC execution unit building block 2310.

A dual MAC 2321 of MAC execution unit building block 2320 is coupled to perform a multiply-accumulate operation on the fetched first input data and on the saved third input data stored in buffer 2315 and a multiply-accumulate operation on the fetched second input data and on saved fourth input data input one computation cycle ago and stored in a buffer 2316 of MAC execution unit building block 2310. A dual MAC 2322 of MAC execution unit building block 2320 is coupled to perform a multiply-accumulate operation on the fetched first input data and on the saved fourth input data stored in buffer 2316 and a multiply-accumulate operation on the fetched second input data and on saved seventh input data input one computation cycle ago and stored in a buffer 2335 of MAC execution unit building block 2330. A dual MAC 2323 of MAC execution unit building block 2320 is coupled to perform a multiply-accumulate operation on the fetched first input data and on the saved seventh input data stored in buffer 2335 and a multiply-accumulate operation on the fetched second input data and on saved eighth input data input one computation cycle ago and stored in a buffer 2336 of MAC execution unit building block 2330. A dual MAC 2324 of MAC execution unit building block 2320 is coupled to perform a multiply-accumulate operation on the fetched first input data and on the saved eighth input data stored in buffer 2336 and a multiply-accumulate operation on the fetched second input data and on saved third input data input two computation cycles ago and stored in a buffer 2325 of MAC execution unit building block 2320.

A dual MAC 2331 of MAC execution unit building block 2330 is coupled to perform a multiply-accumulate operation on the fetched fifth and seventh input data and a multiply-accumulate operation on the fetched sixth and eighth input data. A dual MAC 2332 of MAC execution unit building block 2330 is coupled to perform a multiply-accumulate operation on the fetched fifth and eighth input data and a multiply-accumulate operation on the fetched sixth input data and on the saved third input data stored in buffer 2315. A dual MAC 2333 of MAC execution unit building block 2330 is coupled to perform a multiply-accumulate operation on the fetched fifth input data and on the saved third input data stored in buffer 2315 and a multiply-accumulate operation on the fetched sixth input data and on the saved fourth input data stored in buffer 2316. A dual MAC 2334 of MAC execution unit building block 2330 is coupled to perform a multiply-accumulate operation on the fetched fifth input data and on the saved fourth input data stored in buffer 2316 and a multiply-accumulate operation on the fetched sixth input data and on the saved seventh input data stored in buffer 2335.

A dual MAC 2341 of MAC execution unit building block 2340 is coupled to perform a multiply-accumulate operation on the fetched fifth input data and on the saved seventh input data stored in buffer 2335 and a multiply-accumulate operation on the fetched sixth input data and on the saved eighth input data stored in buffer 2336. A dual MAC 2342 of MAC execution unit building block 2340 is coupled to perform a multiply-accumulate operation on the fetched fifth input data and on the saved eighth input data stored in buffer 2336 and a multiply-accumulate operation on the fetched sixth input data and on the saved third input data stored in buffer 2325. A dual MAC 2343 of MAC execution unit building block 2340 is coupled to perform a multiply-accumulate operation on the fetched fifth input data and on the saved third input data stored in buffer 2325 and a multiply-accumulate operation on the fetched sixth input data and on saved fourth input data input two computation cycles ago and stored in a buffer 2326 of MAC execution unit building block 2320. A dual MAC 2344 of MAC execution unit building block 2340 is coupled to perform a multiply-accumulate operation on the fetched fifth input data and on the saved fourth input data stored in buffer 2326 and a multiply-accumulate operation on the fetched sixth input data and on saved seventh input data input two computation cycles ago and stored in a buffer 2345 of MAC execution unit building block 2340. Any data stored in an additional buffer 2346 of MAC execution unit building block 2340 for one embodiment may not be used.

MAC execution unit building block 2310 for one embodiment may be implemented by combining two smaller MAC execution unit building blocks: one having dual MACs 2311 and 2312 and two buffers and one having dual MACs 2313 and 2314 and buffers 2315 and 2316. MAC execution unit building block 2320 for one embodiment may be implemented by combining two smaller MAC execution unit building blocks: one having dual MACs 2321 and 2322 and two buffers and one having dual MACs 2323 and 2324 and buffers 2325 and 2326. MAC execution unit building block 2330 for one embodiment may be implemented by combining two smaller MAC execution unit building blocks: one having dual MACs 2331 and 2332 and two buffers and one having dual MACs 2333 and 2334 and buffers 2335 and 2336. MAC execution unit building block 2340 for one embodiment may be implemented by combining two smaller MAC execution unit building blocks: one having dual MACs 2341 and 2342 and two buffers and one having dual MACs 2343 and 2344 and buffers 2345 and 2346.

MAC execution unit 205 of FIG. 23 for one embodiment may use only eight input data to perform thirty-two multiply-accumulate operations for a computation cycle.

MAC execution unit 205 of FIG. 23 may be used, for example, to help compute one or more FIR digital filter output data samples in accordance with the above FIR digital filter Equation 1. MAC execution unit 205 of FIG. 23 may be used to compute four taps per computation cycle on eight output data samples.

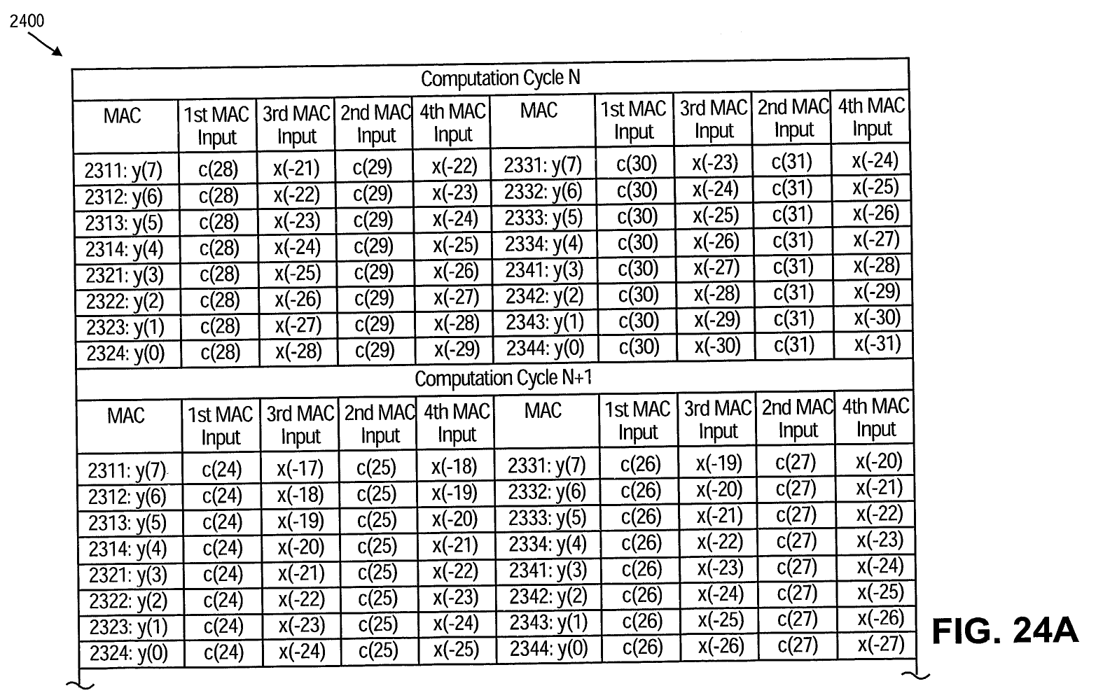

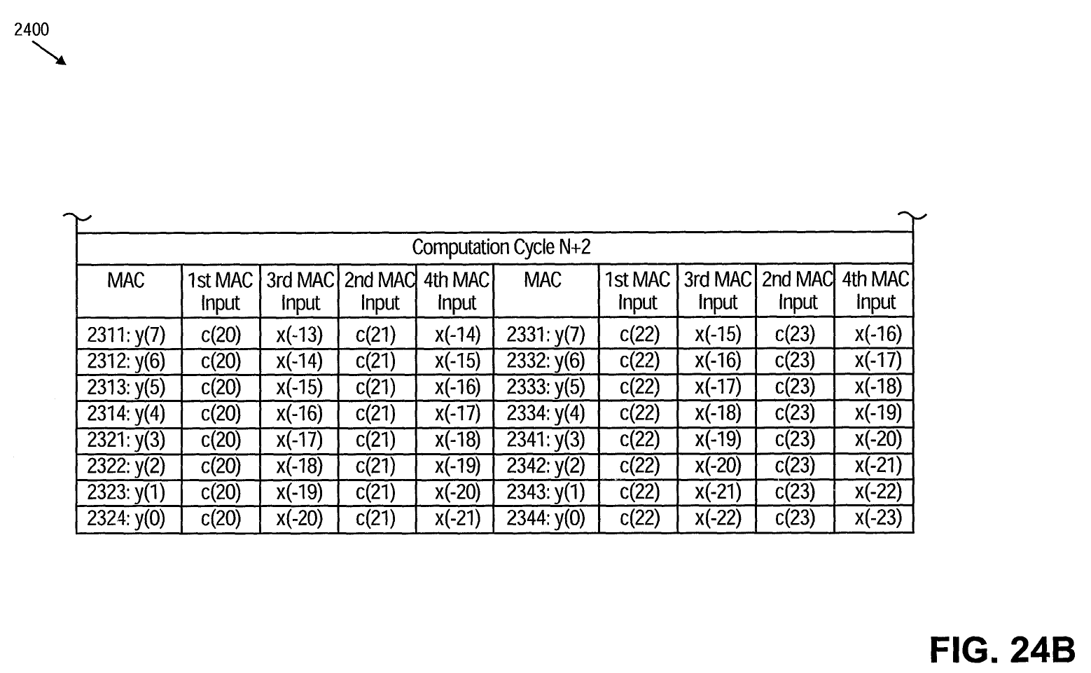

Given a filter length of L=32, for example, MAC execution unit 205 of FIG. 23 may be used to compute, for example, output data sample y(7) with dual MACs 2311 and 2331, output data sample y(6) with dual MACs 2312 and 2332, output data sample y(5) with dual MACs 2313 and 2333, output data sample y(4) with dual MACs 2314 and 2334, output data sample y(3) with dual MACs 2321 and 2341, output data sample y(2) with dual MACs 2322 and 2342, output data sample y(1) with dual MACs 2323 and 2343, and output data sample y(0) with dual MACs 2324 and 2344 in accordance with a table 2400 of FIG. 24. As two dual MACs are used for each output data sample for one embodiment, the resulting accumulated sums computed by the two dual MACs may be added by execution logic 204, for example, to compute the output data sample.

As illustrated in FIG. 24, four fetched input data samples are input for each computation cycle N, N+1, N+2, etc. The first three input data samples are saved for re-use for the next two computation cycles, and the fourth input data sample is saved for re-use for the next one computation cycle. As one example, input data samples x(−21), x(−22), and x(−23) are saved for re-use for computation cycles N+1 and N+2, and input data sample x(−24) is saved for re-use for computation cycle N+1. For each computation cycle N, N+1, N+2, etc., seven input data samples are saved for re-use for the next computation cycle.

Four fetched tap coefficients are input for each computation cycle N, N+1, N+2, etc. Tap coefficients for one embodiment may not be saved by MAC execution unit 205 for re-use but rather may be re-input when computing another set of output data samples, such as output data samples y(15), y(14), y(13), y(12), y(11), y(10), y(9), and y(8) for example, with dual MACs 2311, 2312, 2313, 2314, 2321, 2322, 2323, 2324, 2331, 2332, 2333, 2334, 2341, 2342, 2343, and 2344.

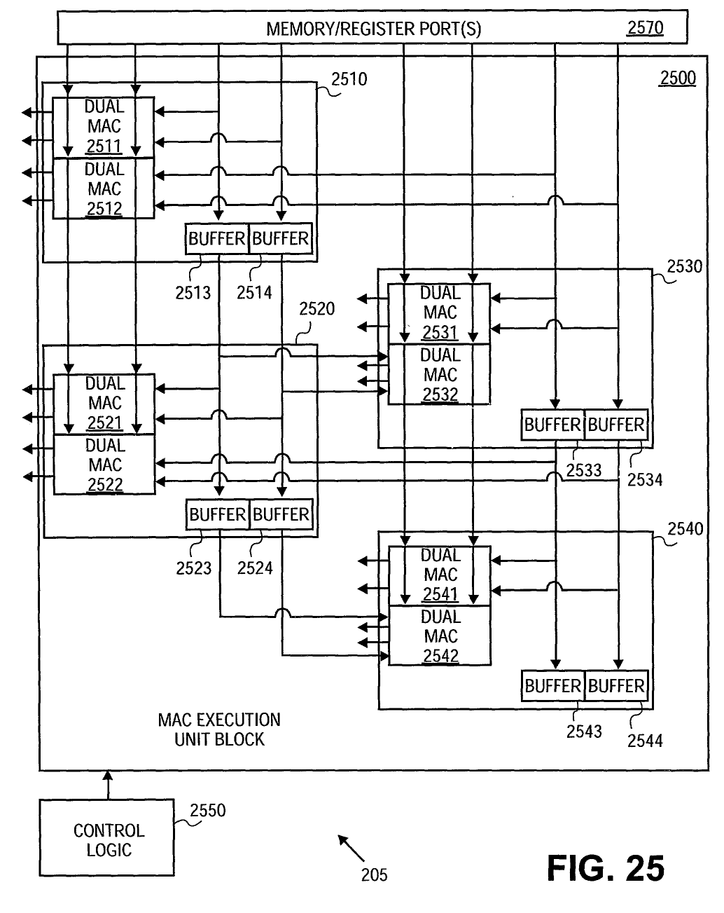

### FIG. 25 Example

MAC execution unit 205 for another embodiment, as illustrated in FIG. 25 may be implemented with four MAC execution unit building blocks 2510, 2520, 2530, and 2540. As illustrated in FIG. 25, MAC execution unit 205 comprises a MAC execution unit block 2500 and control logic 2550. Control logic 2550 for one embodiment may control MAC execution unit block 2500 in accordance with one or more MAC SIMD instructions, for example.

MAC execution unit block 2500 comprises MAC execution unit building blocks 2510, 2520, 2530, and 2540. MAC execution unit building block 2510 is coupled to receive fetched first, second, third, fourth, seventh, and eighth input data from one or more memory or register ports 2570. MAC execution unit building block 2520 is coupled to receive the fetched first and second input data from one or more memory or register ports 2570 and saved input data from MAC execution unit building blocks 2510 and 2530. MAC execution unit building block 2530 is coupled to receive the fetched seventh and eighth input data and fetched fifth and sixth input data from one or more memory or register ports 2570 and saved input data from MAC execution unit building block 2510. MAC execution unit building block 2540 is coupled to receive the fetched fifth and sixth input data from one or more memory or register ports 2570 and saved input data from MAC execution unit building blocks 2520 and 2530.

A dual MAC 2511 of MAC execution unit building block 2510 is coupled to perform a multiply-accumulate operation on the fetched first and third input data and a multiply-accumulate operation on the fetched second and fourth input data. A dual MAC 2512 of MAC execution unit building block 2510 is coupled to perform a multiply-accumulate operation on the fetched first and seventh input data and a multiply-accumulate operation on the fetched second and eighth input data.

A dual MAC 2521 of MAC execution unit building block 2520 is coupled to perform a multiply-accumulate operation on the fetched first input data and on saved third input data input one computation cycle ago and stored in a buffer 2513 of MAC execution unit building block 2510. Dual MAC 2521 is also coupled to perform a multiply-accumulate operation on the fetched second input data and on saved fourth input data input one computation cycle ago and stored in a buffer 2514 of MAC execution unit building block 2510. A dual MAC 2522 of MAC execution unit building block 2520 is coupled to perform a multiply-accumulate operation on the fetched first input data and on saved seventh input data input one computation cycle ago and stored in a buffer 2533 of MAC execution unit building block 2530. Dual MAC 2522 is also coupled to perform a multiply-accumulate operation on the fetched second input data and on saved eighth input data input one computation cycle ago and stored in a buffer 2534 of MAC execution unit building block 2530.

A dual MAC 2531 of MAC execution unit building block 2530 is coupled to perform a multiply-accumulate operation on the fetched fifth and seventh input data and a multiply-accumulate operation on the fetched sixth and eighth input data. A dual MAC 2532 of MAC execution unit building block 2530 is coupled to perform a multiply-accumulate operation on the fetched fifth input data and on the saved third input data stored in buffer 2513 and a multiply-accumulate operation on the fetched sixth input data and on the saved fourth input data stored in buffer 2514.

A dual MAC 2541 of MAC execution unit building block 2540 is coupled to perform a multiply-accumulate operation on the fetched fifth input data and on the saved seventh input data stored in buffer 2533 and a multiply-accumulate operation on the fetched sixth input data and on the saved eighth input data stored in buffer 2534. A dual MAC 2542 of MAC execution unit building block 2540 is coupled to perform a multiply-accumulate operation on the fetched fifth input data and on saved third input data input two computation cycles ago and stored in a buffer 2523 of MAC execution unit building block 2520. Dual MAC 2542 of MAC execution unit building block 2540 is also coupled to perform a multiply-accumulate operation on the fetched sixth input data and on saved fourth input data input two computation cycles ago and stored in a buffer 2524 of MAC execution unit building block 2520. Any data stored in buffers 2543 and/or 2544 of MAC execution unit building block 2540 for one embodiment may not be used.

MAC execution unit 205 of FIG. 25 for one embodiment may use only eight input data to perform sixteen multiply-accumulate operations for a computation cycle.

MAC execution unit 205 of FIG. 25 may be used, for example, to help compute one or more FIR digital filter output data samples in accordance with the above FIR digital filter Equation 1 with 2:1 decimation. MAC execution unit 205 of FIG. 25 may be used to compute four taps per computation cycle on four output data samples.

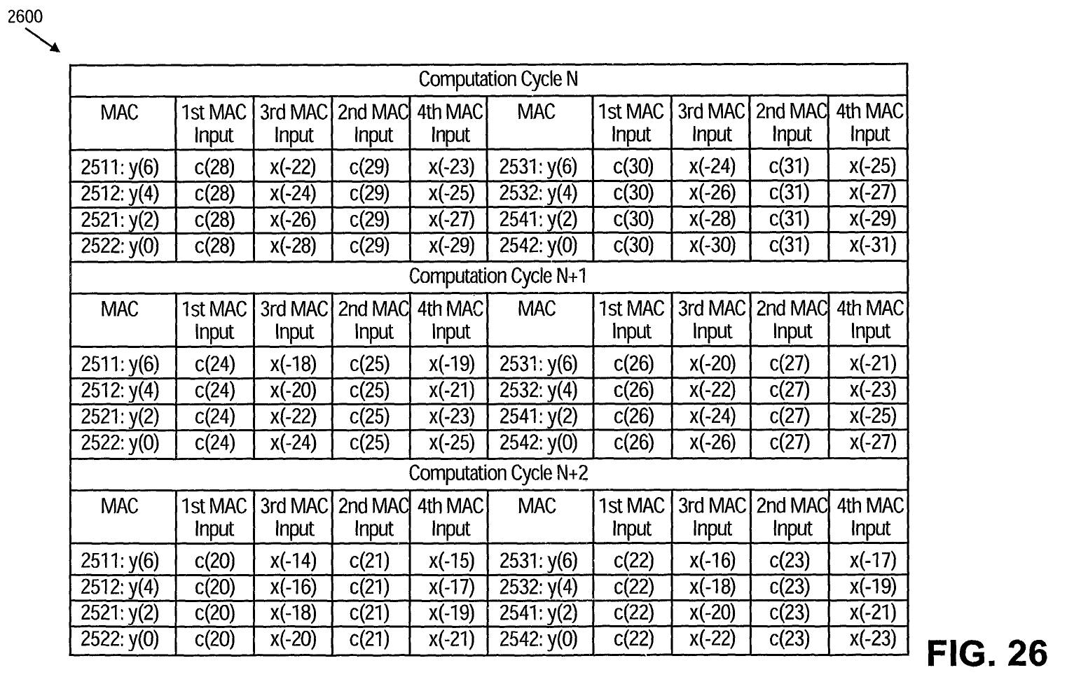

Given a filter length of L=32, for example, MAC execution unit 205 of FIG. 25 may be used to compute, for example, output data sample y(6) with dual MACs 2511 and 2531, output data sample y(4) with dual MACs 2512 and 2532, output data sample y(2) with dual MACs 2521 and 2541, and output data sample y(0) with dual MACs 2522 and 2542 in accordance with a table 2600 of FIG. 26. As two dual MACs are used for each output data sample for one embodiment, the resulting accumulated sums computed by the two dual MACs may be added by execution logic 204, for example, to compute the output data sample.

As illustrated in FIG. 26, four fetched input data samples are input for each computation cycle N, N+1, N+2, etc. The first two input data samples are saved for re-use for the next two computation cycles, and the third and fourth input data samples are saved for re-use for the next one computation cycle. As one example, input data samples x(−22) and x(−23) are saved for re-use for computation cycles N+1 and N+2, and input data samples x(−24) and x(−25) are saved for re-use for computation cycle N+1. For each computation cycle N, N+1, N+2, etc., six input data samples are saved for re-use for the next computation cycle.

Four fetched tap coefficients are input for each computation cycle N, N+1, N+2, etc. Tap coefficients for one embodiment may not be saved by MAC execution unit 205 for re-use but rather may be re-input when computing another set of output data samples, such as output data samples y(14), y(12), y(10), and y(8) for example, with dual MACs 2511, 2512, 2521, 2522, 2531, 2532, 2541, and 2542.

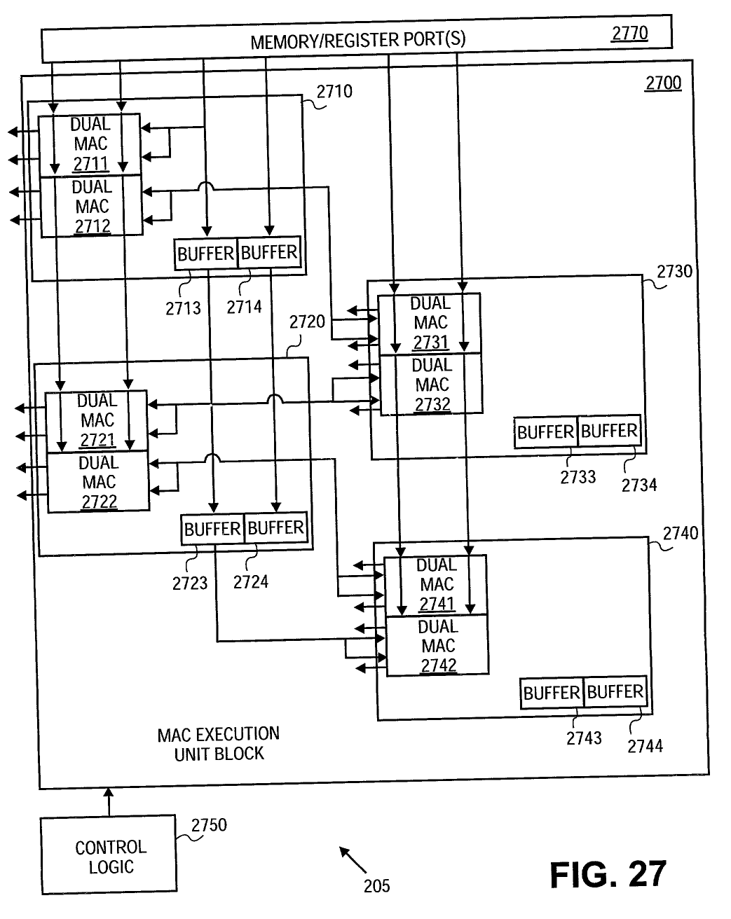

### FIG. 27 Example

MAC execution unit 205 for another embodiment, as illustrated in FIG. 27 may be implemented with four MAC execution unit building blocks 2710, 2720, 2730, and 2740. As illustrated in FIG. 27, MAC execution unit 205 comprises a MAC execution unit block 2700 and control logic 2750. Control logic 2750 for one embodiment may control MAC execution unit block 2700 in accordance with one or more MAC SIMD instructions, for example.

MAC execution unit block 2700 comprises MAC execution unit building blocks 2710, 2720, 2730, and 2740. MAC execution unit building block 2710 is coupled to receive fetched first, second, third, and fourth input data from one or more memory or register ports 2770. MAC execution unit building block 2720 is coupled to receive the fetched first and second input data from one or more memory or register ports 2770 and saved input data from MAC execution unit building block 2710. MAC execution unit building block 2730 is coupled to receive the fetched fourth input data and fetched fifth and sixth input data from one or more memory or register ports 2770 and saved input data from MAC execution unit building block 2710. MAC execution unit building block 2740 is coupled to receive the fetched fifth and sixth input data from one or more memory or register ports 2770 and saved input data from MAC execution unit building blocks 2710 and 2720.

A dual MAC 2711 of MAC execution unit building block 2710 is coupled to perform a multiply-accumulate operation on the fetched first and third input data and a multiply-accumulate operation on the fetched second and third input data. A dual MAC 2712 of MAC execution unit building block 2710 is coupled to perform a multiply-accumulate operation on the fetched first and fourth input data and a multiply-accumulate operation on the fetched second and fourth input data.

A dual MAC 2721 of MAC execution unit building block 2720 is coupled to perform a multiply-accumulate operation on the fetched first input data and on saved third input data input one computation cycle ago and stored in a buffer 2713 of MAC execution unit building block 2710. Dual MAC 2721 is also coupled to perform a multiply-accumulate operation on the fetched second input data and on the saved third input data stored in buffer 2713. A dual MAC 2722 of MAC execution unit building block 2720 is coupled to perform a multiply-accumulate operation on the fetched first input data and on saved fourth input data input one computation cycle ago and stored in a buffer 2714 of MAC execution unit building block 2710. Dual MAC 2722 is also coupled to perform a multiply-accumulate operation on the fetched second input data and on the saved fourth input data stored in buffer 2714.

A dual MAC 2731 of MAC execution unit building block 2730 is coupled to perform a multiply-accumulate operation on the fetched fifth and fourth input data and a multiply-accumulate operation on the fetched sixth and fourth input data. A dual MAC 2732 of MAC execution unit building block 2730 is coupled to perform a multiply-accumulate operation on the fetched fifth input data and on the saved third input data stored in buffer 2713 and a multiply-accumulate operation on the fetched sixth input data and on the saved third input data stored in buffer 2713.

A dual MAC 2741 of MAC execution unit building block 2740 is coupled to perform a multiply-accumulate operation on the fetched fifth input data and on the saved fourth input data stored in buffer 2714 and a multiply-accumulate operation on the fetched sixth input data and on the saved fourth input data stored in buffer 2714. A dual MAC 2742 of MAC execution unit building block 2740 is coupled to perform a multiply-accumulate operation on the fetched fifth input data and on saved third input data input two computation cycles ago and stored in a buffer 2723 of MAC execution unit building block 2720. Dual MAC 2742 of MAC execution unit building block 2740 is also coupled to perform a multiply-accumulate operation on the fetched sixth input data and on the saved third input data stored in buffer 2723. Any data stored in an additional buffer 2724 of MAC execution unit building block 2720, in buffers 2733 and/or 2734 of MAC execution unit building block 2730, and/or in buffers 2743 and/or 2744 of MAC execution unit building block 2740 for one embodiment may not be used.

MAC execution unit 205 of FIG. 27 for one embodiment may use only six input data to perform sixteen multiply-accumulate operations for a computation cycle.

MAC execution unit 205 of FIG. 27 may be used, for example, to help compute one or more FIR digital filter output data samples in accordance with the above FIR digital filter Equation 1 with 1:2 interpolation. MAC execution unit 205 of FIG. 27 may be used to compute four taps per computation cycle on eight output data samples.

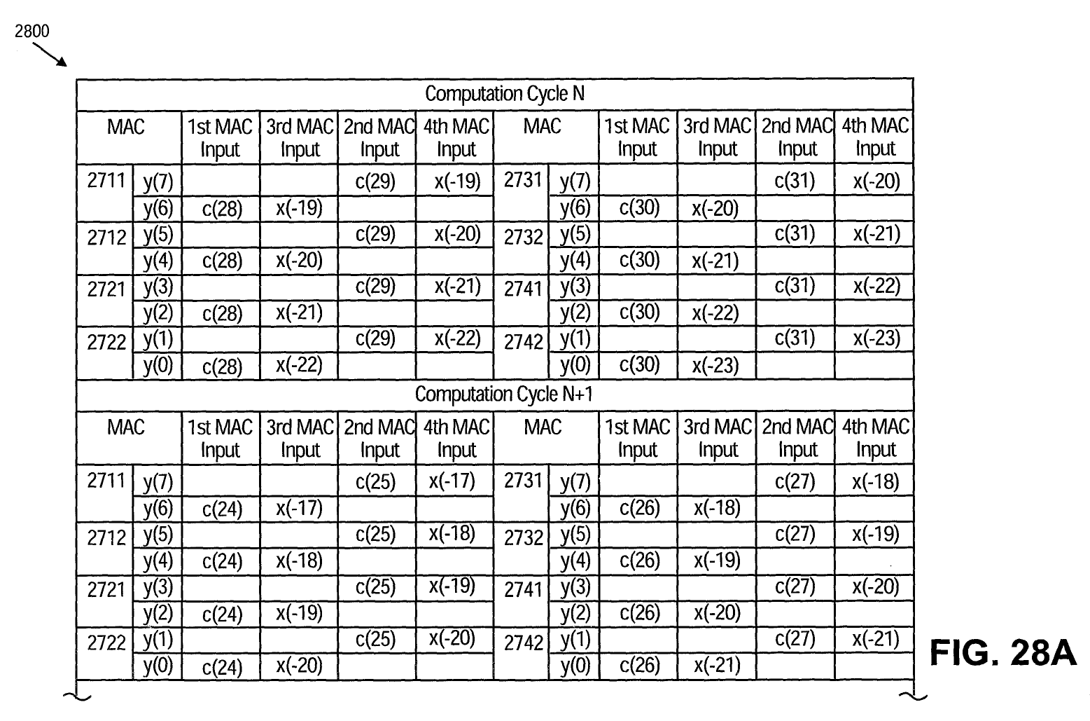

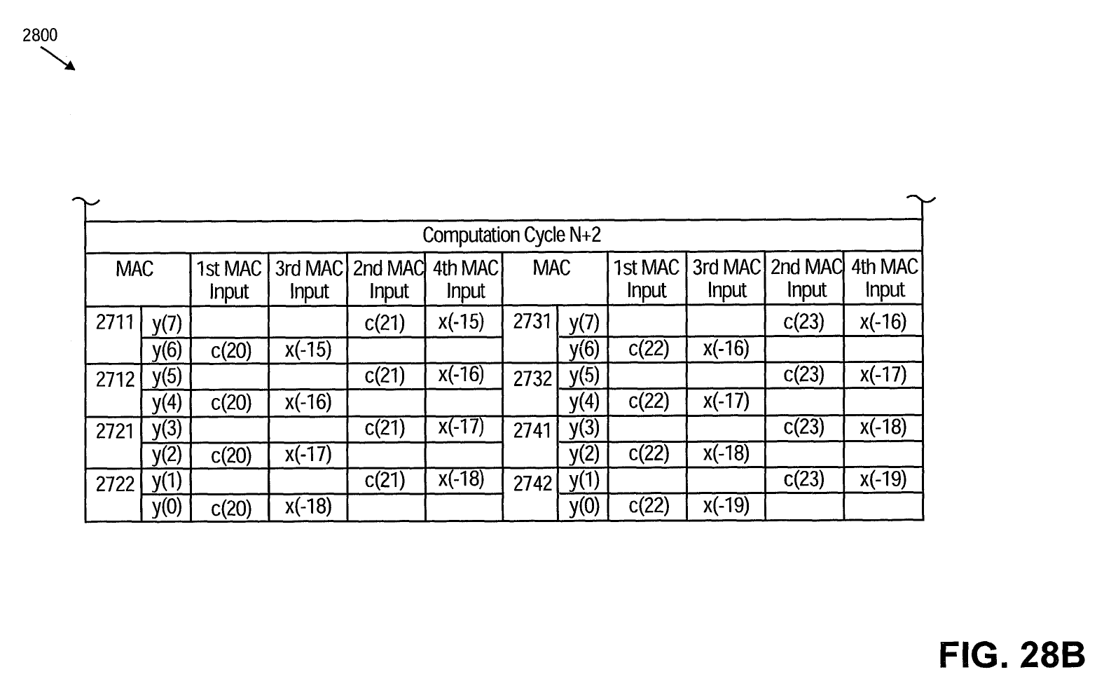

Given a filter length of L=32, for example, MAC execution unit 205 of FIG. 27 may be used to compute, for example, output data samples y(7) and y(6) with dual MACs 2711 and 2731, output data samples y(5) and y(4) with dual MACs 2712 and 2732, output data samples y(3) and y(2) with dual MACs 2721 and 2741, and output data samples y(1) and y(0) with dual MACs 2722 and 2742 in accordance with a table 2800 of FIG. 28. As two dual MACs are used for each output data sample for one embodiment, the resulting accumulated sums computed by the two dual MACs for the output data sample may be added by execution logic 204, for example, to compute the output data sample.

As illustrated in FIG. 28, two fetched input data samples are input for each computation cycle N, N+1, N+2, etc. The first input data sample is saved for re-use for the next two computation cycles, and the second input data sample is saved for re-use for the next one computation cycle. As one example, input data sample x(−19) is saved for re-use for computation cycles N+1 and N+2, and input data sample x(−20) is saved for re-use for computation cycle N+1. For each computation cycle N, N+1, N+2, etc., three input data samples are saved for re-use for the next computation cycle.

Four fetched tap coefficients are input for each computation cycle N, N+1, N+2, etc. Tap coefficients for one embodiment may not be saved by MAC execution unit 205 for re-use but rather may be re-input when computing another set of output data samples, such as output data samples y(15), y(14), y(13), y(12), y(11), y(10), y(9), and y(8) for example, with dual MACs 2711, 2712, 2721, 2722, 2731, 2732, 2741, and 2742.

Although illustrated in FIGS. 13, 15, 17, 19, 21, 23, 25, and 27 as being implemented with one or more MAC execution unit building blocks providing fixed couplings to input data to one or more MACs, MAC execution unit 205 for other embodiments may be similarly implemented with one or more MAC execution unit building blocks similar to MAC execution unit building block 1100, that is with one or more MAC execution unit building blocks comprising one or more multiplexers in place of one or more fixed couplings to input data to one or more MACs selectively. MAC execution unit 205 for one embodiment may comprise suitable control logic to control each multiplexer. MAC execution unit 205 for one embodiment may control each multiplexer in accordance with one or more MAC SIMD instructions, for example.

Although described in the context of fetching tap coefficients in a descending index order and input data samples in an ascending index order in implementing a FIR digital filter, MAC execution unit 205 for other embodiments may fetch tap coefficients and input data samples in any suitable order. Although described in the context of saving only input data samples for re-use in implementing a FIR digital filter, MAC execution unit 205 for other embodiments may save tap coefficients for re-use while re-inputting input data samples when computing later sets of output data samples.

In the foregoing description, the invention has been described with reference to specific exemplary embodiments thereof. It will, however, be evident that various modifications and changes may be made thereto without departing from the broader spirit or scope of the present invention as defined in the appended claims. The specification and drawings are, accordingly, to be regarded in an illustrative rather than a restrictive sense.

What is claimed is:

1. A method comprising:
receiving input data by an execution unit; and
performing by the execution unit one or more current multiply-accumulate operations on the received input data and on input data received by the execution unit for one or more prior multiply-accumulate operations and saved by the execution unit.

2. The method of claim 1, wherein the receiving comprises receiving first and second data by the execution unit; and
wherein the performing comprises performing by the execution unit a multiply-accumulate operation on the received first and second data and a multiply-accumulate operation on the received first data and on input data saved by the execution unit.

3. The method of claim 1, wherein the receiving comprises receiving first, second, third, and fourth data by the execution unit; and
wherein the performing comprises performing by the execution unit a multiply-accumulate operation on the received first and third data, a multiply-accumulate operation on the received second and fourth data, a multiply-accumulate operation on the received first and fourth data, and a multiply-accumulate operation on the received second data and on input data saved by the execution unit.

4. The method of claim 3, wherein the performing the multiply-accumulate operation on the received first and third data and the multiply-accumulate operation on the received second and fourth data comprise multiplying the received first and third data to produce a first product, multiplying the received second and fourth data to produce a second product, and adding the first product, the second product, and an accumulated sum.

5. The method of claim 1, comprising:
saving by the execution unit received input data for one or more multiply-accumulate operations to be performed by the execution unit after the current multiply-accumulate operations;
repeating the receiving, performing, and saving by the execution unit one or more times to accumulate data; and
outputting the accumulated data by the execution unit.

6. The method of claim 5, comprising performing the repeating to implement a finite impulse response filter, wherein the received input data comprises one or more tap coefficients and one or more input data samples and wherein the accumulated data comprises one or more output data samples.

7. The method of claim 6, wherein one or more tap coefficients are each a complex number and one or more input data samples are each a complex number.

8. The method of claim 1, comprising saving by the execution unit saved input data for one or more multiply-accumulate operations to be performed by the execution unit.

9. The method of claim 1, comprising performing the receiving and performing in accordance with a single instruction multiple data instruction.

10. An apparatus comprising:
an execution unit block having a plurality of inputs, the execution unit block comprising one or more buffers to save input data received at one or more of the inputs and a plurality of multiplier-accumulators to perform multiply-accumulate operations, the multiplier-accumulators to perform current multiply-accumulate operations on input data received at one or more of the inputs and on input data received by the execution unit block for one or more prior multiply-accumulate operations and stored in one or more buffers of the execution unit block; and
control logic to control the multiplier-accumulators and the one or more buffers.

11. The apparatus of claim 10, the multiplier-accumulators to perform a multiply-accumulate operation on first and second input data received at the inputs and a multiply-accumulate operation on the received first input data and on input data stored in a buffer of the execution unit block.

12. The apparatus of claim 11, wherein the execution unit block comprises a single multiplier-accumulator comprising a multiplier to multiply the received first and second input data to produce a product, an accumulator to store an accumulated sum, and an adder to add the product to the accumulated sum.

13. The apparatus of claim 10, the multiplier-accumulators to perform a multiply-accumulate operation on first and third input data received at the inputs, a multiply-accumulate operation on second and fourth data received at the inputs, a multiply-accumulate operation on the received first and fourth data, and a multiply-accumulate operation on the received second data and on input data stored in a buffer of the execution unit block.

14. The apparatus of claim 13, wherein the execution unit block comprises a dual multiplier-accumulator comprising a multiplier to multiply the received first and third input data to produce a first product, a multiplier to multiply the received second and fourth input data to produce a second product, an accumulator to store an accumulated sum, and an adder to add the first product, the second product, and the accumulated sum.

15. The apparatus of claim 10, the execution unit block comprising one or more execution unit building blocks each comprising one or more multiplier-accumulators and one or more buffers.

16. The apparatus of claim 10, the control logic to control the execution unit block to repeat, one or more times, receiving input data at one or more of the inputs, performing multiply-accumulate operations on the received input data and on input data stored in one or more buffers of the execution unit block to accumulate data, and saving the received input data in one or more buffers of the execution unit block.

17. The apparatus of claim 16, the multiplier-accumulators to perform the repeating to implement a finite impulse response filter, wherein the received input data comprises one or more tap coefficients and one or more input data samples and wherein the accumulated data comprises one or more output data samples.

18. The apparatus of claim 17, wherein one or more tap coefficients are each a complex number and one or more input data samples are each a complex number.

19. The apparatus of claim 10, the control logic to control the execution unit block to save input data stored in one or more buffers of the execution unit block for one or more multiply-accumulate operations to be performed by the execution unit block.

20. The apparatus of claim 10, the control logic to control the multiplier-accumulators and the one or more buffers in accordance with a single instruction multiple data instruction.

21. A system comprising:
(a) a coder/decoder to receive analog signals and convert the analog signals into corresponding input data; and
(b) a processor to process the corresponding input data, the processor comprising:
(i) an execution unit block having a plurality of inputs, the execution unit block comprising one or more buffers to save input data received at one or more of the inputs and a plurality of multiplier-accumulators to perform multiply-accumulate operations, the multiplier-accumulators to perform current multiply-accumulate operations on input data received at one or more of the inputs and on input data received by the execution unit block for one or more prior multiply-accumulate operations and stored in one or more buffers of the execution unit block, and
(ii) control logic to control the multiplier-accumulators and the one or more buffers.

22. The system of claim 21, the multiplier-accumulators to perform a multiply-accumulate operation on first and second input data received at the inputs and a multiply-accumulate operation on the received first input data and on input data stored in a buffer of the execution unit block.

23. The system of claim 22, wherein the execution unit block comprises a single multiplier-accumulator comprising a multiplier to multiply the received first and second input data to produce a product, an accumulator to store an accumulated sum, and an adder to add the product to the accumulated sum.

24. The system of claim 21, the multiplier-accumulators to perform a multiply-accumulate operation on first and third input data received at the inputs, a multiply-accumulate operation on second and fourth data received at the inputs, a multiply-accumulate operation on the received first and fourth data, and a multiply-accumulate operation on the received second data and on input data stored in a buffer of the execution unit block.

25. The system of claim 24, wherein the execution unit block comprises a dual multiplier-accumulator comprising a multiplier to multiply the received first and third input data to produce a first product, a multiplier to multiply the received second and fourth input data to produce a second product, an accumulator to store an accumulated sum, and an adder to add the first product, the second product, and the accumulated sum.

26. The system of claim 21, the execution unit block comprising one or more execution unit building blocks each comprising one or more multiplier-accumulators and one or more buffers.

27. The system of claim 21, the control logic to control the execution unit block to repeat, one or more times, receiving input data at one or more of the inputs, performing multiply-accumulate operations on the received input data and on input data stored in one or more buffers of the execution unit block to accumulate data, and saving the received input data in one or more buffers of the execution unit block.

28. The system of claim 27, the multiplier-accumulators to perform the repeating to implement a finite impulse response filter, wherein the received input data comprises one or more tap coefficients and one or more input data samples and wherein the accumulated data comprises one or more output data samples.

29. The system of claim 21, the control logic to control the execution unit block to save input data stored in one or more buffers of the execution unit block for one or more multiply-accumulate operations to be performed by the execution unit block.

30. The system of claim 21, the control logic to control the multiplier-accumulators and the one or more buffers in accordance with a single instruction multiple data instruction.
